(19) United States
(12) Patent Application Publication
(10) Pub. No.: US 2024/0113834 A1
(43) Pub. Date: Apr. 4, 2024

(54) SIGNALING OF SOUNDING REFERENCE SIGNAL GROUPING

(71) Applicant: QUALCOMM INCORPORATED, San Diego, CA (US)

(72) Inventors: Ahmed ELSHAFIE, San Diego, CA (US); Runxin WANG, San Diego, CA (US); Muhammad Sayed Khairy ABDELGHAFFAR, San Jose, CA (US); Yu ZHANG, San Diego, CA (US); Krishna Kiran MUKKAVILLI, San Diego, CA (US); Hwan Joon KWON, San Diego, CA (US); Tingfang JI, San Diego, CA (US)

(21) Appl. No.: 18/264,743

(22) PCT Filed: Apr. 7, 2021
(86) PCT No.: PCT/CN2021/085778

§ 371 Date: Aug. 8, 2023

(51) Int. Cl. H04L 5/00; H04W 72/02; H04W 72/0446; H04W 72/231

(52) U.S. Cl. CPC H04L 5/0051; H04W 72/02; H04W 72/0446; H04W 72/231

(57) ABSTRACT

Methods, systems, and devices for wireless communications are described. A user equipment (UE) may identify one or more antenna groups at the UE, each of the one or more antenna groups comprising two or more antenna ports and associated with group-based sounding reference signal transmission. The UE may receive an indication of a sounding reference signal configuration identifying one or more resources for performing group-based sounding reference signal transmissions using at least one of the one or more antenna groups. The UE may transmit one or more sounding reference signals using the one or more resources and at least one antenna port from the at least one of the one or more antenna groups.

### CROSS REFERENCE

The present application is a 371 national stage filing of International PCT Application No. PCT/CN2021/085778 by ELSHAFIE et al. entitled “SIGNALING OF SOUNDING REFERENCE SIGNAL GROUPING,” filed Apr. 7, 2021, which is assigned to the assignee hereof, and which is expressly incorporated by reference in its entirety herein.

### FIELD OF TECHNOLOGY

The following relates to wireless communications, including signaling of sounding reference signal grouping.

### BACKGROUND

Wireless communication systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support signaling of sounding reference signal (SRS) grouping. Generally, the described techniques provide for resource configuration for SRS sounding based at least in part on antenna grouping at the user equipment (UE). For example, a base station may configure a UE with a configuration identifying resources for group-based SRS transmissions (e.g., antenna group-based). The resources may include a plurality of resource sets, with at least one resource set being available for full sounding (a sounding that involves every SRS antenna group of the UE) and at least one resource set for partial sounding (a sounding that involves fewer than all of the SRS antenna groups of the UE). The partial sounding resource set may be identified by a number (e.g., identifier) that corresponds to the antenna group that is to be sounded. Alternatively, the partial sounding resource set may be identified by an index that corresponds to multiple antenna groups that are to be sounded. In another alternative, the resources may include a single resource set, with the resource set including resources that may be applied to either full sounding or to partial sounding. The full/partial sounding resources may be sounded according to a periodic schedule, e.g., based on a trigger signal. Accordingly, the UE may perform sounding by transmitting SRS using at least one antenna group from the available antenna groups and according to the SRS resource configuration.

A method for wireless communication at a UE is described. The method may include identifying one or more antenna groups at the UE, each of the one or more antenna groups including two or more antenna ports and associated with group-based SRS transmission, receiving an indication of a SRS configuration identifying one or more resources for performing group-based SRS transmissions using at least one of the one or more antenna groups, and transmitting one or more SRSs using the one or more resources and at least one antenna port from the at least one of the one or more antenna groups.

An apparatus for wireless communication at a UE is described. The apparatus may include a processor, memory coupled with the processor, and instructions stored in the memory. The instructions may be executable by the processor to cause the apparatus to identify one or more antenna groups at the UE, each of the one or more antenna groups including two or more antenna ports and associated with group-based SRS transmission, receive an indication of a SRS configuration identifying one or more resources for performing group-based SRS transmissions using at least one of the one or more antenna groups, and transmit one or more SRSs using the one or more resources and at least one antenna port from the at least one of the one or more antenna groups.

Another apparatus for wireless communication at a UE is described. The apparatus may include means for identifying one or more antenna groups at the UE, each of the one or more antenna groups including two or more antenna ports and associated with group-based SRS transmission, means for receiving an indication of a SRS configuration identifying one or more resources for performing group-based SRS transmissions using at least one of the one or more antenna groups, and means for transmitting one or more SRSs using the one or more resources and at least one antenna port from the at least one of the one or more antenna groups.

A non-transitory computer-readable medium storing code for wireless communication at a UE is described. The code may include instructions executable by a processor to identify one or more antenna groups at the UE, each of the one or more antenna groups including two or more antenna ports and associated with group-based SRS transmission, receive an indication of a SRS configuration identifying one or more resources for performing group-based SRS transmissions using at least one of the one or more antenna groups, and transmit one or more SRSs using the one or more resources and at least one antenna port from the at least one of the one or more antenna groups.

Some examples of the method, apparatuses, and non-transitory computer-readable medium described herein may further include operations, features, means, or instructions for identifying, based on the SRS configuration, a set of multiple resource sets and selecting one of the set of multiple resource sets for transmission of the one or more SRSs, the one of the set of multiple resource sets including the one or more resources.

In some examples of the method, apparatuses, and non-transitory computer-readable medium described herein, the set of multiple resource sets include a first resource set associated with a full resource set identifier indicative of first resources to be used for a sounding using all of the one or more antenna groups, and a second resource set associated with a partial resource identifier indicative of second resources to be used for a sounding using fewer than all of the one or more antenna groups.

In some examples of the method, apparatuses, and non-transitory computer-readable medium described herein, the first resources and the second resources may be different.

In some examples of the method, apparatuses, and non-transitory computer-readable medium described herein, the set of multiple resource sets include a first resource set associated with a full resource set identifier indicative of first resources to be used for a sounding using all of the one or more antenna groups, and a set of multiple second resource sets each associated with a partial resource identifier indicative of corresponding second resources to be used for a sounding using fewer than all of the one or more antenna groups.

Some examples of the method, apparatuses, and non-transitory computer-readable medium described herein may further include operations, features, means, or instructions for identifying, based on the SRS configuration, a resource set including the one or more resources, the one or more resources associated with a partial resource identifier indicating that the one or more resources may be to be used for a sounding using fewer than all of the one or more antenna groups.

Some examples of the method, apparatuses, and non-transitory computer-readable medium described herein may further include operations, features, means, or instructions for identifying, based on the SRS configuration, a number of antennas to be sounded within the one or more antenna groups.

In some examples of the method, apparatuses, and non-transitory computer-readable medium described herein, transmitting the one or more SRSs may include operations, features, means, or instructions for transmitting, during a first time period, a first set of full SRS transmissions and transmitting, during a second time period, a second set of partial SRS transmissions.

Some examples of the method, apparatuses, and non-transitory computer-readable medium described herein may further include operations, features, means, or instructions for receiving a trigger indicating to switch from the first time period where the first set of full SRS transmissions occur to the second time period where the second set of partial SRS transmissions occur.

Some examples of the method, apparatuses, and non-transitory computer-readable medium described herein may further include operations, features, means, or instructions for identifying, based on the SRS configuration, a periodicity associated with the first time period, the second time period, or both, where switching from the first time period to the second time period may be based on the periodicity.

In some examples of the method, apparatuses, and non-transitory computer-readable medium described herein, the trigger may be received via at least one of a downlink control information (DCI) message, a medium access control (MAC) control element (CE), or both.

Some examples of the method, apparatuses, and non-transitory computer-readable medium described herein may further include operations, features, means, or instructions for identifying, based on the trigger, a partial resource identifier indicating that one or more resources may be to be used for a sounding using fewer than all of the one or more antenna groups.

In some examples of the method, apparatuses, and non-transitory computer-readable medium described herein, the trigger indicates either a full resource set identifier indicative of first resources to be used for a sounding using all of the one or more antenna groups during the first time period or a partial resource identifier indicative of corresponding second resources to be used for a sounding using fewer than all of the one or more antenna groups during the second time period.

In some examples of the method, apparatuses, and non-transitory computer-readable medium described herein, the trigger indicates common resources to be used for a sounding using all of the one or more antenna groups during the first time period and for a sounding using fewer than all of the one or more antenna groups during the second time period.

Some examples of the method, apparatuses, and non-transitory computer-readable medium described herein may further include operations, features, means, or instructions for transmitting a UE capability message identifying the one or more antenna groups at the UE, where the indication of the SRS configuration identifying the one or more resources may be received based on the UE capability message.

A method for wireless communication at a base station is described. The method may include identifying one or more antenna groups at a UE, each of the one or more antenna groups including two or more antenna ports and associated with group-based SRS transmission, transmitting an indication of a SRS configuration identifying one or more resources for performing group-based SRS transmissions from the UE using at least one of the one or more antenna groups, and receiving one or more SRSs using the one or more resources and at least one antenna port from the at least one of the one or more antenna groups.

An apparatus for wireless communication at a base station is described. The apparatus may include a processor, memory coupled with the processor, and instructions stored in the memory. The instructions may be executable by the processor to cause the apparatus to identify one or more antenna groups at a UE, each of the one or more antenna groups including two or more antenna ports and associated with group-based SRS transmission, transmit an indication of a SRS configuration identifying one or more resources for performing group-based SRS transmissions from the UE using at least one of the one or more antenna groups, and receive one or more SRSs using the one or more resources and at least one antenna port from the at least one of the one or more antenna groups.

Another apparatus for wireless communication at a base station is described. The apparatus may include means for identifying one or more antenna groups at a UE, each of the one or more antenna groups including two or more antenna ports and associated with group-based SRS transmission, means for transmitting an indication of a SRS configuration identifying one or more resources for performing group-based SRS transmissions from the UE using at least one of the one or more antenna groups, and means for receiving one or more SRSs using the one or more resources and at least one antenna port from the at least one of the one or more antenna groups.

A non-transitory computer-readable medium storing code for wireless communication at a base station is described. The code may include instructions executable by a processor to identify one or more antenna groups at a UE, each of the one or more antenna groups including two or more antenna ports and associated with group-based SRS transmission, transmit an indication of a SRS configuration identifying one or more resources for performing group-based SRS transmissions from the UE using at least one of the one or more antenna groups, and receive one or more SRSs using the one or more resources and at least one antenna port from the at least one of the one or more antenna groups.

In some examples of the method, apparatuses, and non-transitory computer-readable medium described herein, the SRS configuration identifies a set of multiple resource sets, and one of the set of multiple resource sets may be selected by the UE for transmission of the one or more SRSs, the one of the set of multiple resource sets including the one or more resources.

In some examples of the method, apparatuses, and non-transitory computer-readable medium described herein, the set of multiple resource sets include a first resource set associated with a full resource set identifier indicative of first resources to be used for a sounding using all of the one or more antenna groups, and a second resource set associated with a partial resource identifier indicative of second resources to be used for a sounding using fewer than all of the one or more antenna groups.

In some examples of the method, apparatuses, and non-transitory computer-readable medium described herein, the first resources and the second resources may be different.

In some examples of the method, apparatuses, and non-transitory computer-readable medium described herein, the set of multiple resource sets include a first resource set associated with a full resource set identifier indicative of first resources to be used for a sounding using all of the one or more antenna groups, and a set of multiple second resource sets each associated with a partial resource identifier indicative of corresponding second resources to be used for a sounding using fewer than all of the one or more antenna groups.

In some examples of the method, apparatuses, and non-transitory computer-readable medium described herein, the SRS configuration identifies a resource set including the one or more resources, the one or more resources associated with a partial resource identifier indicating that the one or more resources may be to be used for a sounding using fewer than all of the one or more antenna groups.

In some examples of the method, apparatuses, and non-transitory computer-readable medium described herein, the SRS configuration identifies a number of antennas to be sounded within the one or more antenna groups.

In some examples of the method, apparatuses, and non-transitory computer-readable medium described herein, receiving the one or more SRSs may include operations, features, means, or instructions for receiving, during a first time period, a first set of full SRS transmissions and receiving, during a second time period, a second set of partial SRS transmissions.

Some examples of the method, apparatuses, and non-transitory computer-readable medium described herein may further include operations, features, means, or instructions for transmitting a trigger indicating to switch from the first time period where the first set of full SRS transmissions occur to the second time period where the second set of partial SRS transmissions occur.

In some examples of the method, apparatuses, and non-transitory computer-readable medium described herein, the SRS configuration identifies a periodicity associated with the first time period, the second time period, or both, and the UE switching from the first time period to the second time period may be based on the periodicity.

In some examples of the method, apparatuses, and non-transitory computer-readable medium described herein, the trigger may be transmitted via at least one of a DCI message, a MAC CE, or both.

Some examples of the method, apparatuses, and non-transitory computer-readable medium described herein may further include operations, features, means, or instructions for identifying, in the trigger, a partial resource identifier indicating that one or more resources may be to be used for a sounding using fewer than all of the one or more antenna groups.

In some examples of the method, apparatuses, and non-transitory computer-readable medium described herein, the trigger indicates either a full resource set identifier indicative of first resources to be used for a sounding using all of the one or more antenna groups during the first time period or a partial resource identifier indicative of corresponding second resources to be used for a sounding using fewer than all of the one or more antenna groups during the second time period.

In some examples of the method, apparatuses, and non-transitory computer-readable medium described herein, the trigger indicates common resources to be used for a sounding using all of the one or more antenna groups during the first time period and for a sounding using fewer than all of the one or more antenna groups during the second time period.

Some examples of the method, apparatuses, and non-transitory computer-readable medium described herein may further include operations, features, means, or instructions for receiving a UE capability message identifying the one or more antenna groups at the UE, where the indication of the SRS configuration identifying the one or more resources may be transmitted based on the UE capability message.

### BRIEF DESCRIPTION OF THE DRAWINGS

FIG. 1 illustrates an example of a wireless communication system that supports signaling of sounding reference signal (SRS) grouping in accordance with aspects of the present disclosure.

FIG. 2 illustrates an example of a wireless communication system that supports signaling of SRS grouping in accordance with aspects of the present disclosure.

FIG. 3 illustrates an example of a wireless communication system that supports signaling of SRS grouping in accordance with aspects of the present disclosure.

FIG. 4 illustrates an example of a sounding configuration that supports signaling of SRS grouping in accordance with aspects of the present disclosure.

FIG. 5 illustrates an example of a process that supports signaling of SRS grouping in accordance with aspects of the present disclosure.

FIGS. 6 and 7 show block diagrams of devices that support signaling of SRS grouping in accordance with aspects of the present disclosure.

FIG. 8 shows a block diagram of a communications manager that supports signaling of SRS grouping in accordance with aspects of the present disclosure.

FIG. 9 shows a diagram of a system including a device that supports signaling of SRS grouping in accordance with aspects of the present disclosure.

FIGS. 10 and 11 show block diagrams of devices that support signaling of SRS grouping in accordance with aspects of the present disclosure.

FIG. 12 shows a block diagram of a communications manager that supports signaling of SRS grouping in accordance with aspects of the present disclosure.

FIG. 13 shows a diagram of a system including a device that supports signaling of SRS grouping in accordance with aspects of the present disclosure.

FIGS. 14 through 18 show flowcharts illustrating methods that support signaling of SRS grouping in accordance with aspects of the present disclosure.

### DETAILED DESCRIPTION

Some user equipment (UEs) in a wireless communication system may use sounding reference signal (SRS) antenna grouping for SRS transmissions. For example, uplink sounding using every available antenna of a UE may take considerable time/resources to sound the channel between the UE and a base station. To address this, the UE may divide the UE's antennas into groups and then only sound one or more antenna from each group (instead of all of the antennas). For example, the UE may indicate the correlation among its antennas within an antenna group to the base station. The base station may then use the information from the UE to understand which antennas are being sounded and which antennas are grouped with the sounded antennas so that the base station may apply the reduced-number SRS transmissions to all of the antennas. However, current techniques do not provide an efficient mechanism to indicate resources for the uplink sounding within the antenna grouping scenario.

Aspects of the disclosure are initially described in the context of wireless communication systems. Generally, the described techniques provide for resource configuration for SRS sounding based at least in part on antenna grouping at the UE. For example, a base station may configure a UE with a configuration identifying resources for group-based SRS transmissions (e.g., antenna group-based). The resources may include a plurality of resource sets, with at least one resource set being available for full sounding (a sounding that involves every SRS antenna group of the UE) and at least one resource set for partial sounding (a sounding that involves fewer than all of the SRS antenna groups of the UE). The partial sounding resource set may be identified by a number (e.g., identifier) that corresponds to the antenna group that is to be sounded. Alternatively, the partial sounding resource set may be identified by an index that corresponds to multiple antenna groups that are to be sounded. In another alternative, the resources may include a single resource set, with the resource set including resources that may be applied to either full sounding or to partial sounding. The full/partial sounding resources may be sounded according to a periodic schedule, e.g., based on a trigger signal. Accordingly, the UE may perform sounding by transmitting SRS using at least one antenna group from the available antenna groups and according to the SRS resource configuration.

Aspects of the disclosure are further illustrated by and described with reference to apparatus diagrams, system diagrams, and flowcharts that relate to signaling on sounding reference signal grouping.

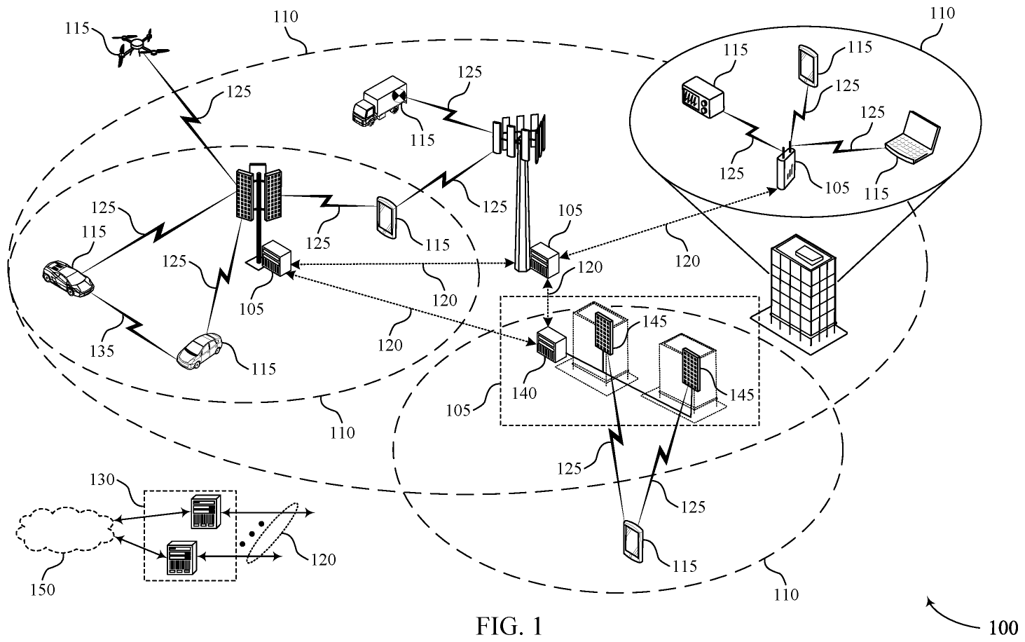

FIG. 1 illustrates an example of a wireless communication system 100 that supports signaling of sounding reference signal grouping in accordance with aspects of the present disclosure. The wireless communication system 100 may include one or more base stations 105, one or more UEs 115, and a core network 130. In some examples, the wireless communication system 100 may be a Long Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may identify one or more antenna groups at the UE 115, each of the one or more antenna groups comprising two or more antenna ports and associated with group-based SRS transmission. The UE 115 may receive an indication of an SRS configuration identifying one or more resources for performing group-based SRS transmissions using at least one of the one or more antenna groups. The UE 115 may transmit one or more SRS signals using the one or more resources and at least one antenna port from the at least one of the one or more antenna groups.

A base station 105 may identifying one or more antenna groups at a UE 115, each of the one or more antenna groups comprising two or more antenna ports and associated with group-based SRS transmission. The base station 105 may transmit an indication of an SRS configuration identifying one or more resources for performing group-based SRS transmissions from the UE 115 using at least one of the one or more antenna groups. The base station 105 may receive one or more SRSs using the one or more resources and at least one antenna port from the at least one of the one or more antenna groups.

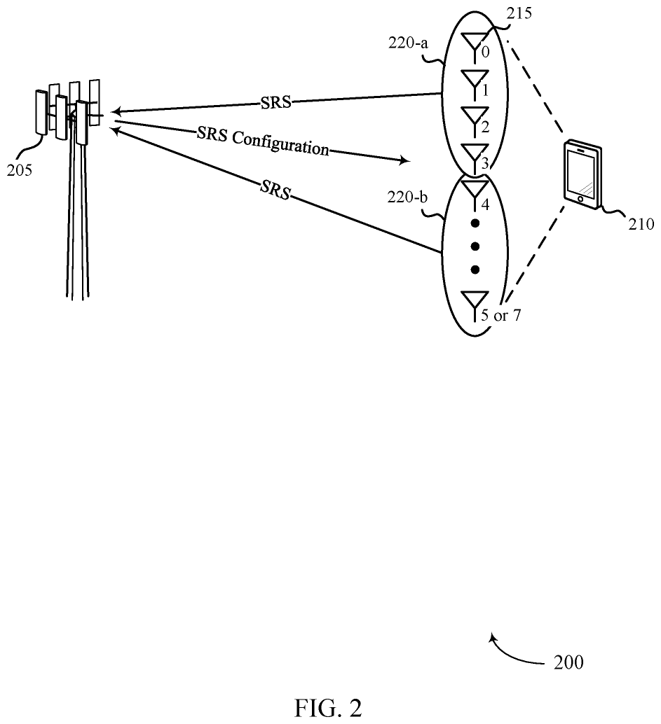

FIG. 2 illustrates an example of a wireless communication system 200 that supports signaling of SRS grouping in accordance with aspects of the present disclosure. Wireless communication system 200 may implement aspects of wireless communication system 100. Wireless communication system 200 may include base station 205 and UE 210, which may be examples of the corresponding devices described herein.

UE 210 may use SRS antenna grouping for SRS transmissions wherein one or more antennas 215 (with 5 or 7 antennas 215 being shown by way of example only) being sounding within the antenna groups of UE 210. For example, uplink sounding using every available antenna of UE 210 would take considerable time/resources to sound the channel between UE 210 and base station 205. Generally, using more antennas leads to more time/power resources being required for the uplink sounding. For example, a UE having 6/8 receive antennas may not sound all of the available antennas due to large insertion losses. If there is some fixed relationship between different groups of antennas 215, some information (e.g., correlation information) may be reported to base station 205 without requiring SRS transmissions and without introducing additional time/power resources for the SRS soundings.

In some aspects, UE 210 may support SRS grouping where the available antenna ports (e.g., antennas 215) of UE 210 are divided into one or more antenna groups 220 (with two antenna groups 220 being shown by way of example only). Although antenna group 220-a is shown as having four antennas 215 and antenna group 220-b is shown as having two or four antennas 215, it is to be understood that the number of antenna groups 220, as well as the number of antennas 215 within each antenna group 220, may be different. For example, some antenna groups 220 may have more or fewer than two or four antennas 215 as well as there may be more of fewer than two antenna groups 220.

In some aspects, this approach may support UE-assisted channel reconstruction based on a partial spatial sounding (e.g., only sounding one or more antennas 215 within an antenna group 220). That is, UE 210 may only sound from some antennas 215, which may be used along with additional correlation information (e.g., correlation information regarding antennas 215 within an antenna group 220). To that end, base station 205 and/or UE 210 may divide the antennas 215 of UE 210 into groups, and then only sound (e.g., transmit) one or more antennas 215 from each antenna group 220. UE 210 may transmit or otherwise provide an indication of the correlation information to base station 205. The correlation information may indicate correlation information (e.g., quasi-colocation (QCL) information, antenna port configuration/capabilities, etc.) among the antennas 215 within the same antenna group 220. Base station 205 may then interpolate/extrapolate information based on the correlation information and the uplink sounding (e.g., SRS transmissions from UE 210 using at least one antenna 215 from each antenna group 220) to determine the full channel matrix (e.g., to determine the channel performance characteristics). This may support more intelligent allocation/configuration decisions of base station 205 for wireless communications with UE 210.

As discussed, the antenna grouping of antennas 215 of UE 210 into antenna groups 220 may take various approaches. In some aspects, the antenna grouping (e.g., for SRS grouping) may be based on the SRS grouping capability of UE 210. For example, UE 210 may transmit or otherwise provide a UE capability message to base station 205 reporting its SRS grouping capability, which may also include an indication of the SRS switching capability of UE 210. For example, the UE capability message may indicate number, capability, configuration, etc., of its antennas 215 as well as the transmit and/or receive chains of UE 210. The UE capability message may indicate the correlation information among the antennas 215, although the correlation information may be signaled separately.

In some aspects, the antenna grouping may be uniform or non-uniform. For example, UE 210 may be configured with, or otherwise support, UE 210 may transmit an indication of support for xTyGzR antenna grouping, where xT may correspond to the number of transmit chains/antennas 215, yG may correspond to the number of antenna port groups, and zR may correspond to the number of receive chains/antennas 215 of UE 210. Non-limiting examples of the antenna groupings may include xT4G2R (xT8R), xT2G4R (xT8R), which may correspond to four receive chains/antennas 215 in the first group, two receive chains/antennas 215 in the second group, resulting in xT2G (xT6R). A non-uniform grouping may include UE 210 sounding a y antenna in the first antenna group 220 (e.g., antenna group 220-a) and then sounding x antenna in the second antenna group 220 (e.g., antenna group 220-b).

Accordingly, in some examples UE 210 may divide the UE's antennas 215 into antenna groups 220 and then only sound one or more antenna 215 from each antenna group 220 (instead of all of the antennas). For example, UE 215 may indicate the correlation among its antennas 215 within an antenna group 220 to base station 205. Base station 205 may then use the information from UE 210 to understand which antennas 215 are being sounded and which antennas 215 are grouped with the sounded antennas so that base station 205 may apply the reduced-number of SRS transmissions to all of the antennas 215 within the antenna group 220. However, current techniques do not provide an efficient mechanism to indicate resources for the uplink sounding within the antenna grouping scenario.

Accordingly, aspects of the described techniques provide various mechanisms that may be used to configure UE 210 with SRS resources for group-based SRS transmissions. Broadly, the described techniques provide mechanisms for base station 205 to indicate to UE 210 to use one or more (or all) of the antenna groups for UE SRS sounding. Base station 205 may also dynamically indicate a change to the antenna grouping. For example, base station 205 and/or UE 210 may identify or otherwise determine one or more antenna groups of UE 210. Each of the antenna group(s) may include two or more antenna ports (e.g., antenna 215) that may be used for, or otherwise associated with, group-based SRS transmissions from UE 210.

For example, UE 210 may transmit or otherwise provide to base station 205 a UE capability message indicating its support for group-based SRS sounding. For example, the UE capability message may identify or otherwise indicate the number of antenna ports (e.g., antennas 215), the number of transmit and/or receiving chains, various capabilities of the antenna ports and/or transmit/receive chains, and the like. In some aspects, the UE capability message may identify or otherwise indicate whether and/or how UE 210 supports SRS switching, group-based SRS sounding, etc. In some aspects, the UE capability message may identify the groups that UE 210 has grouped antennas 215 into. In some aspects, the UE capability message may be transmitted via an uplink channel (e.g., PUCCH and/or PUSCH). In one example, the UE capability message may be transmitted or otherwise indicated in RRC signaling. Accordingly, UE 210 may identify its antenna group(s) based on its configuration, and base station 205 may identify the antenna group(s) of UE 210 based on the UE capability message.

Base station 205 may transmit or otherwise provide to UE 210 an indication of an SRS configuration for group-based SRS transmissions. Broadly, the SRS configuration may allocate, configure, or otherwise identify resource(s) for performing the group-based SRS transmissions. This may include UE 210 performing the group-based SRS transmissions using the allocated resources for transmitting SRS(s). UE 210 may perform the SRS transmissions using at least one antenna port (e.g., antenna 215) from at least one of the antenna group(s). For example, UE 210 may transmit SRS(s) using at least one antenna 215 from antenna group 220-a and transmit SRS(s) using at least one antenna 215 from antenna group 220-b.

In some examples, the resources configured for the group-based SRS transmissions from UE 210 may include multiple SRS resource sets being indicated. For example, base station 205 and/or UE 210 may determine, select, or otherwise identify that the resource configuration (e.g., SRS-ResourceSet) configures a plurality of resource sets (e.g., SRS resource sets. Accordingly, UE 210 may select at least one of the plurality of resource sets SRS transmissions. In some aspects, this may include at least one resource set (e.g., srs-a first resource set indicated by FullResourceSetID) of the plurality of resource sets identifying, configuring, or otherwise being associated with a full resource set identifier indicating first resources for sounding all of the antenna groups. For example, the srs-FullResourceSetID may indicate or otherwise identify the SRS resource set (e.g., SRS-ResourceSetId) to be used for full SRS sounding. In some aspects, this may include at least one resource set (e.g., a second resource set indicated by srs-PartialResourceSetID) of the plurality of resource sets identifying, configuring, or otherwise being associated with a partial resource set identifier indicating a partial resource identifier for sounding some of the antenna groups. For example, the srs-PartialResourceSetID may indicate or otherwise identify the SRS resource set (e.g., an integer value (0 . . . maxNrofSRS-PartialResourceSets-1) to be used for partial SRS sounding. In some aspects, this may include the configuration (e.g., SRS-ResourceSet) indicating a plurality of second resource sets, each being associated with a partial resource identifier (e.g., srs-PartialResourceSetId) to be used for partial sounding.

In some examples, the first resource set (e.g., srs-FullResourceID) and the second resource set (e.g., srs-PartialResourceID) may identify the same time, frequency, spatial, code, etc., resources or may identify different resources. Base station 205 may configure multiple SRS resource sets, each SRS resource set allocating or otherwise identifying SRS resources. Some SRS resource set(s) may be used for full sounding (e.g., SRS sounding using at least antenna 215 from all antenna groups 220). Some SRS resource set(s) (e.g., maxNrofSRS-PartialResourceSets) may be used for partial port sounding (e.g., partial SRS sounding), such as some SRS resources for antenna group 220-a, some SRS resources for antenna group 220-b, etc. For example, the configuration (e.g., SRS-ResourceSet) may identify a first SRS resource set for full sounding using at least one antenna from each antenna group 220, a second SRS resource set for partial sounding using at least one antenna 215 from antenna group 220-a, a third SRS resource set for partial sounding using at least one antenna 215 from antenna group 220-b, etc. In some aspects, the full sounding SRS resource set(s) and the partial sounding SRS resource set(s) may use the same resources, at least partially overlapping resources, and/or different resources. The identifier link may be configured within the full sounding and partial sounding SRS resource set(s).

In some examples, the described techniques may support a single SRS resource set being indicated. The resource set may be indicated in the SRS setting (e.g., SRS-Resource) indicated via RRC signaling from base station 205 to UE 210. For example, the SRS configuration (e.g., SRS-Resource) may allocate, select, or otherwise identify a single resource set that includes resource(s) associated with a partial resource identifier (e.g., srs-PartialResourceSetID) indicating that resource(s) (e.g., an integer value of (0 . . . maxNrofSRS-PartialResources-1) are to be used for sounding using fewer than all of the antenna groups 220. Accordingly, UE 210 may determine or otherwise identify a resource set (e.g., an SRS resource set) having resource(s) associated with a partial resource identifier indicating that resource(s) are to be used for sounding fewer than all of the antenna groups 220. In some aspects, the SRS configuration may be used to identify the number of antennas 215 to be sounded within the antenna groups 220. For example, the SRS configuration (e.g., SRS-Resource) may indicate a number of SRS ports to be sounded (e.g., nrofSRS-Ports) identifying an enumerated indication of the antenna ports (e.g., port1, ports2, ports4, etc.).

Accordingly, some examples of the described techniques may include single SRS resource set-based indication. The SRS resource set (e.g., SRS-Resource) carried via RRC signaling may include base station 205 configuring multiple SRS resources for full sounding and partial sounding within one SRS resource set. Multiple sets of parameters may be configured within the SRS resource set. The partial identifier may be used to indicate to UE 210 to use different antenna ports (e.g., antennas 215). The number of SRS ports may be used to indicate how many antenna ports are to be used for the partial sounding.

In some examples, the resources configured for the group-based SRS transmissions from UE 210 may include two-phase SRS sounding. That is, in some examples UE 210 may transmit a first set of full SRS transmissions during a first time period and transmit a second set of partial SRS transmissions during a second time period. For example, base station 205 may transmit or otherwise provide to UE 210 a trigger indicating for UE 210 to switch from transmitting the first set of full SRS transmissions during the first time period to transmitting the second set of partial SRS transmission during the second time period. Accordingly, in some aspects base station 205 and/or UE 210 may identify (e.g., using the SRS configuration) a periodicity associated with the first and second time periods, which may be used to determine the switching. The trigger may a DCI-based trigger, a MAC CE-based trigger, etc. In some examples, the SRS resource configuration may identify a partial resource identifier indicating that resource(s) are to be used for partial sounding (e.g., using fewer than all of the antenna groups 220. For example, the trigger may indicate either a full resource set identifier indicating first resources to be used for full SRS sounding during the first time period and/or a partial resource identifier indicating second resource(s) to be used for partial SRS sounding during the second time period. In some examples, the trigger may indicate or otherwise identify common resources (e.g., time, frequency, spatial, code, etc., resources) that are to be used for full SRS sounding during the first time period and for partial SRS sounding during the second time period.

Accordingly, aspects of the described techniques may support two-phase SRS sounding. The two-phase SRS sounding may include UE 210 switching between full sounding and partial sounding. The full sounding SRS sets and the partial sounding SRS sets may periodically transmitted based on an activation/trigger (e.g., indicating to switch between full SRS sounding during the first time period and partial SRS sounding during the second time period). In some aspects, the periodicity of the switching may be defined using RRC signaling (e.g., in the RRC signaling used to configure the SRS resource set(s) and/or using different RRC signaling). As discussed above, in some examples the switching may be based on MAC CE and/or DCI signaling. For example, MAC CE signaling may, when activating the SRS resource set(s), also indicate the partial identifier (e.g., srs-PartialResourceSetId). In some examples, DCI signaling may, when partial and full sounding set are different, include the partial sounding sets and the full sounding sets being triggered using different trigger lists. In some examples, DCI signaling may, when partial and full sounding set are the same, include the a new DCI field (e.g., r dummy DCI field) indicating a partial identifier associate with the trigger list.

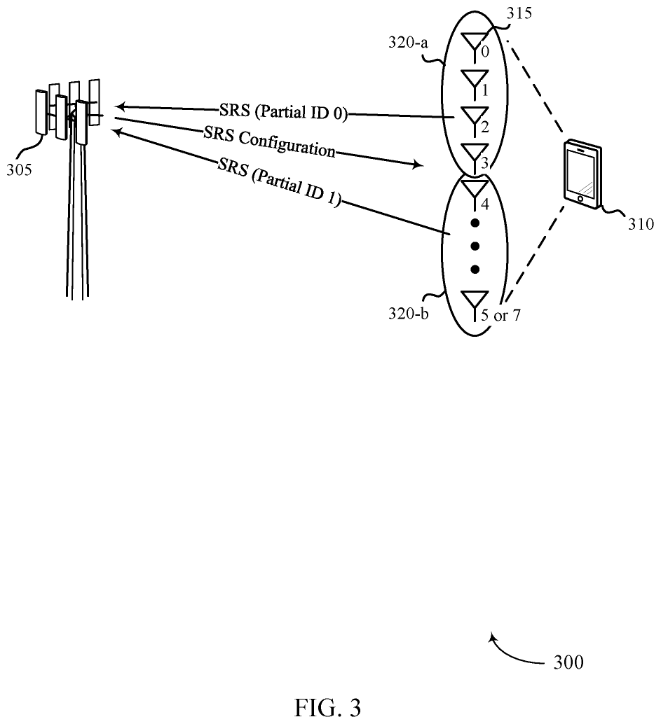

FIG. 3 illustrates an example of a wireless communication system 300 that supports signaling of SRS grouping in accordance with aspects of the present disclosure. Wireless communication system 300 may implement aspects of wireless communication systems 100 and/or 200. Wireless communication system 300 may include base station 305 and UE 310, which may be examples of the corresponding devices described herein.

As discussed above, in some examples UE 310 may divide the UE's antennas 315 into antenna groups 320 and then only sound one or more antenna 315 from each antenna group 320 (instead of all of the antennas). For example, UE 315 may indicate the correlation among its antennas 315 within an antenna group 320 to base station 305. Base station 305 may then use the information from UE 310 to understand which antennas 315 are being sounded and which antennas 315 are grouped with the sounded antennas so that base station 305 may apply the reduced-number of SRS transmissions to all of the antennas 315 within the antenna group 320. However, current techniques do not provide an efficient mechanism to indicate resources for the uplink sounding within the antenna grouping scenario.

Accordingly, aspects of the described techniques provide various mechanisms that may be used to configure UE 310 with SRS resources for group-based SRS transmissions. Broadly, the described techniques provide mechanisms for base station 305 to indicate to UE 310 to use one or more (or all) of the antenna groups for UE SRS sounding. Base station 305 may also dynamically indicate a change to the antenna grouping. For example, base station 305 and/or UE 310 may identify or otherwise determine one or more antenna groups of UE 310. Each of the antenna group(s) may include two or more antenna ports (e.g., antenna 315) that may be used for, or otherwise associated with, group-based SRS transmissions from UE 310. For example, UE 310 may transmit or otherwise provide to base station 305 a UE capability message indicating its support for group-based SRS sounding. For example, the UE capability message may identify or otherwise indicate the number of antenna ports (e.g., antennas 315), the number of transmit and/or receiving chains, various capabilities of the antenna ports and/or transmit/receive chains, identify or otherwise indicate whether and/or how UE 310 supports SRS switching, group-based SRS sounding, identify the groups that UE 310 has grouped antennas 315 into. Accordingly, UE 310 may identify its antenna group(s) based on its configuration, and base station 305 may identify the antenna group(s) 320 of UE 310 based on the UE capability message.

Base station 305 may transmit or otherwise provide to UE 310 an indication of an SRS configuration for group-based SRS transmissions. Broadly, the SRS configuration may allocate, configure, or otherwise identify resource(s) for performing the group-based SRS transmissions. This may include UE 310 performing the group-based SRS transmissions using the allocated resources for transmitting SRS(s). UE 310 may perform the SRS transmissions using at least one antenna port (e.g., antenna 315) from at least one of the antenna group(s) 320. For example, UE 310 may transmit SRS(s) using at least one antenna 315 from antenna group 320-a and transmit SRS(s) using at least one antenna 315 from antenna group 320-b.

Wireless communication system 300 illustrates a non-limiting example of support for a single SRS resource set being indicated. The resource set may be indicated in the SRS setting (e.g., SRS-ResourceSet) indicated via RRC signaling from base station 305 to UE 310. For example, the SRS configuration (e.g., SRS-ResourceSet) may allocate, select, or otherwise identify a single resource set that includes resource(s) associated with a partial resource identifier (e.g., srs-PartialResourceSetID) indicating that resource(s) (e.g., an integer value of (0 . . . maxNrofSRS-PartialResources-1) are to be used for sounding using fewer than all of the antenna groups 320. Accordingly, UE 310 may determine or otherwise identify a resource set (e.g., an SRS resource set) having resource(s) associated with a partial resource identifier (e.g., partial ID 0, partial ID 1, etc.) indicating that resource(s) are to be used for sounding fewer than all of the antenna groups 320. In some aspects, the SRS configuration may be used to identify the number of antennas 315 to be sounded within the antenna groups 320. For example, the SRS configuration (e.g., SRS-Resource) may indicate a number of SRS ports to be sounded (e.g., nrofSRS-Ports) identifying an enumerated indication of the antenna ports (e.g., port1, ports2, ports4, etc.).

Accordingly, some examples of the described techniques may include single SRS resource set-based indication. The SRS resource setting (e.g., SRS-Resource) carried via RRC signaling may include base station 305 configuring multiple SRS resources for full sounding and partial sounding within one SRS resource set. Multiple sets of parameters may be configured within the SRS resource set. For example, the partial identifier (e.g., partial ID 0 associated with antenna group 320-a and partial ID 1 associated with antenna group 320-b) may be used to indicate to UE 310 to use different antenna ports (e.g., antennas 315), where the number of SRS ports may be used to indicate how many antenna ports are to be used for the partial sounding.

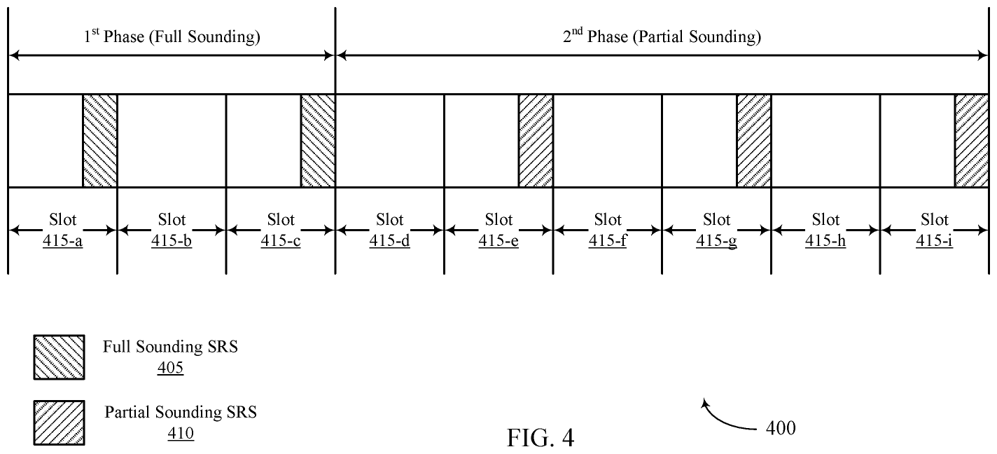

FIG. 4 illustrates an example of a sounding configuration 400 that supports signaling of SRS grouping in accordance with aspects of the present disclosure. Sounding configuration 400 may implement aspects of wireless communication systems 100, 200, and/or 300. Aspects of sounding configuration 400 may be implemented at or implemented by a base station and/or UE, which may be examples of the corresponding devices described herein.

As discussed above, aspects of the described techniques provide various mechanisms that may be used to configure a UE with SRS resources for group-based SRS transmissions. Broadly, the described techniques provide mechanisms for a base station to indicate to the UE to use one or more (or all) of the antenna groups for UE SRS sounding. The base station may also dynamically indicate a change to the antenna grouping. For example, the base station and/or UE may identify or otherwise determine one or more antenna groups of the UE. Each of the antenna group(s) may include two or more antenna ports (e.g., antennas) that may be used for, or otherwise associated with, group-based SRS transmissions from the UE. For example, the UE may transmit or otherwise provide to the base station a UE capability message indicating its support for group-based SRS sounding. Accordingly, the UE may identify its antenna group(s) based on its configuration, and the base station may identify the antenna group(s) of the UE based on the UE capability message.

The base station may transmit or otherwise provide to the UE an indication of an SRS configuration for group-based SRS transmissions. Broadly, the SRS configuration may allocate, configure, or otherwise identify resource(s) for performing the group-based SRS transmissions. This may include the UE performing the group-based SRS transmissions using the allocated resources for transmitting SRS(s). The UE may perform the SRS transmissions using at least one antenna port (e.g., antenna) from at least one of the antenna group(s). For example, the UE may transmit SRS(s) using at least one antenna from a first antenna group and transmit SRS(s) using at least one antenna from a second antenna group.

Sounding configuration 400 illustrates a non-limiting example of where the resources configured for the group-based SRS transmissions from the UE may include two-phase SRS sounding during slots 415. That is, in some examples the UE may transmit a first set of full SRS transmissions (e.g., full sounding SRS 405) during a first time period. The first time period in this context may correspond to the first phase of SRS sounding (e.g., slot 415-a, slot 415-b, and slot 415-c) where full sounding is performed during slot 415-a and slot 415-c. The UE may transmit a second set of partial SRS transmissions (e.g., partial sounding SRS 410) during a second time period. The second time period in this context may correspond to the second phase of SRS sounding (e.g., slot 415-d, slot 415-e, slot 415-f, slot 415-g, slot 415-g, slot 415-h, and slot 415-i) where partial sounding is performed during slot 415-e, slot 415-g, and slot 415-i.

In some examples, this may include the base station transmitting or otherwise providing to the UE a trigger indicating for the UE to switch from transmitting the first set of full SRS transmissions during the first time period to transmitting the second set of partial SRS transmission during the second time period. Accordingly, in some aspects the base station and/or UE may identify (e.g., using the SRS configuration) a periodicity associated with the first and second time periods, which may be used to determine the switching. The trigger may a DCI-based trigger, a MAC CE-based trigger, etc. In some examples, the SRS configuration may identify a partial resource identifier indicating that resource(s) are to be used for partial sounding (e.g., using fewer than all of the antenna groups). For example, the trigger may indicate either a full resource set identifier indicating first resources to be used for full SRS sounding during the first time period and/or a partial resource identifier indicating second resource(s) to be used for partial SRS sounding during the second time period. In some examples, the trigger may indicate or otherwise identify common resources (e.g., time, frequency, spatial, code, etc., resources) that are to be used for full SRS sounding during the first time period and for partial SRS sounding during the second time period.

Accordingly, aspects of the described techniques may support two-phase SRS sounding. The two-phase SRS sounding may include the UE switching between full sounding and partial sounding. The full sounding SRS sets and the partial sounding SRS sets may be periodically transmitted based on an activation/trigger (e.g., indicating to switch between full SRS sounding during the first time period and partial SRS sounding during the second time period). In some aspects, the periodicity of the switching may be defined using RRC signaling (e.g., in the RRC signaling used to configure the SRS resource set(s) and/or using different RRC signaling). As discussed above, in some examples the switching may be based on MAC CE and/or DCI signaling. For example, MAC CE signaling may, when activating the SRS resource set(s), also indicate the partial identifier (e.g., srs-PartialResourceSetId). In some examples, DCI signaling may, when partial and full sounding set are different, include the partial sounding sets and the full sounding sets being triggered using different trigger lists. In some examples, DCI signaling may, when partial and full sounding set are the same, include the a new DCI field (e.g., r dummy DCI field) indicating a partial identifier associate with the trigger list.

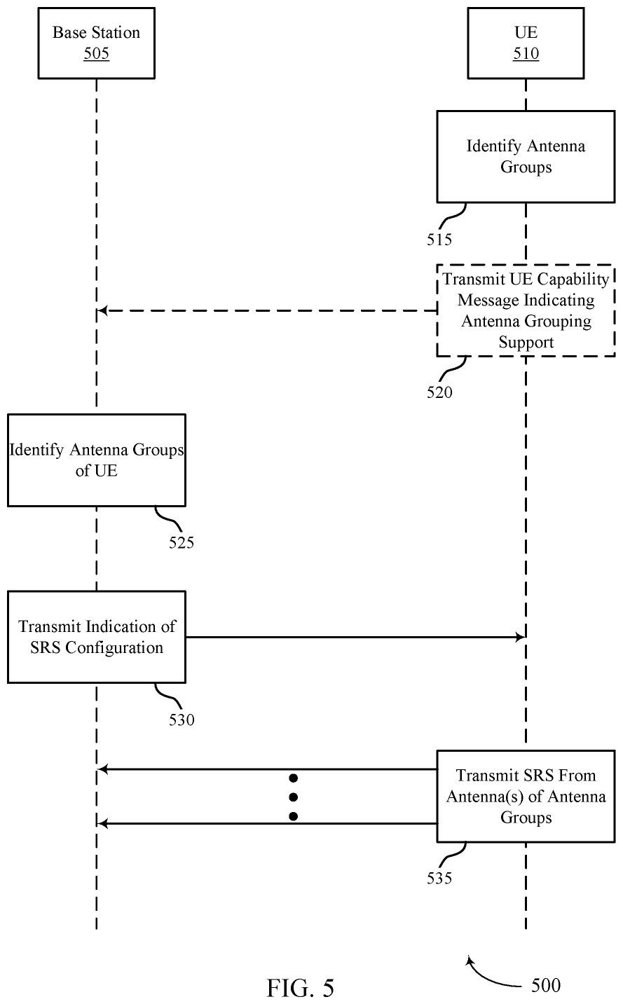

FIG. 5 illustrates an example of a process 500 that supports signaling of SRS grouping in accordance with aspects of the present disclosure. Process 500 may implement aspects of wireless communication systems 100, 200, and/or 300, and/or aspects of sounding configuration 400. Aspects of process 500 may be implemented at and/or implemented by base station 505 and/or UE 510, which may be examples of the corresponding devices described herein.

At 515, UE 510 may determine or otherwise identify antenna group(s) at UE 510. Each antenna group may include two or more antenna ports (e.g., antennas). Each, some or all of the antenna group(s) may be associated with SRS transmissions (e.g., group-based SRS sounding). For example, UE 510 may identify or otherwise determine the number of available antenna ports. UE 510 may identify or otherwise determine correlation between the available antenna ports. UE 510 may group the available antenna ports based on the correlation.

At 520, UE 510 may optionally transmit or otherwise provide (and base station 505 may receive or otherwise obtain) a UE capability message indicating or otherwise identifying the antenna group(s) at UE 510. For example, the UE capability message may identify or otherwise indicate the number of available antenna ports of UE 510, correlation information associated with the available antenna ports, and/or the antenna group(s) of UE 510.

At 525, base station 505 may identify or otherwise determine the antenna group(s) of UE 510. For example, base station 505 may identify the antenna group(s) of UE 510 based on the UE capability message. The UE capability message may be received during initial connection establishment procedures between base station 505 and UE 510 and/or subsequently (e.g., based on negotiations between base station 505 and UE 510 related to group-based SRS sounding).

At 530, base station 505 may transmit or otherwise provide (and UE 510 may receive or otherwise obtain) an indication of an SRS configuration identifying resource(s) for performing group-based SRS transmissions from UE 510 using the antenna group(s). The SRS configuration may be provided via RRC signaling, in some examples, the SRS configuration may identify a plurality of SRS resource sets, with some SRS resource sets identifying resources for full SRS sounding (e.g., SRS sounding using at least one antenna from each antenna group) and other SRS resource sets identifying resources for partial SRS sounding (e.g., SRS sounding using at least one antenna from some of the antenna groups).

At 535, UE 510 may transmit or otherwise provide (and base station 505 may receive or otherwise obtain) SRS(s) using at least one antenna port from at least one of the antenna group(s) of UE 510. For example, UE 510 may perform full SRS sounding and/or partial SRS sounding. The SRS sounding may be performed according to a periodicity associated with switching between full and partial SRS sounding. The SRS sounding may be performed using the resources identified in the SRS configuration.

In some aspects, this may include UE 510 identifying a plurality of resource sets (e.g., SRS resource sets) based on the SRS configuration. That is, the plurality of resource sets may include at least a first resource set associated with a full resource set ID indicative of first resources to use for full sounding (e.g., for sounding using at least one antenna from all/each of the one or more antenna groups) as well as one or more second resource sets to use for partial sounding (e.g., a partial resource identifier indicating the second resources to be used for SRS sounding using at least one antenna from fewer than all of the antenna group(s) of UE 510). The first resources in the first resource set and the second resources in the second resource set may be the same resources or may be different resources (e.g., time, frequency, spatial, code, etc., resources may overlap at least to some degree or may be separate resources).

In some aspects, this may include UE 510 identifying a resource set (e.g., one SRS resource set) that includes resources associated with a partial resource identifier. This may indicate that the resources are to be used for sounding using at least one antenna from fewer than all of the antenna group(s) of UE 510 (e.g., partial sounding). For example, UE 510 may identify the number of antennas to be sounded within the antenna group(s) based on the SRS configuration.

In some aspects, this may include UE 510 transmitting a first set of full SRS transmissions during a first time period (e.g., a first phase) and transmitting a second set of partial SRS transmissions during a second time period (e.g., a second phase). For example, the SRS configuration may identify or otherwise indicate the periodicity associated with switching between the first time period to the second time period, or vice versa. The trigger may be provided via DCI and/or MAC CE. For example, a partial resource identifier indicated in the trigger may identify resources to be used for the partial sounding (e.g., using fewer than all of the antenna group(s) of UE 510).

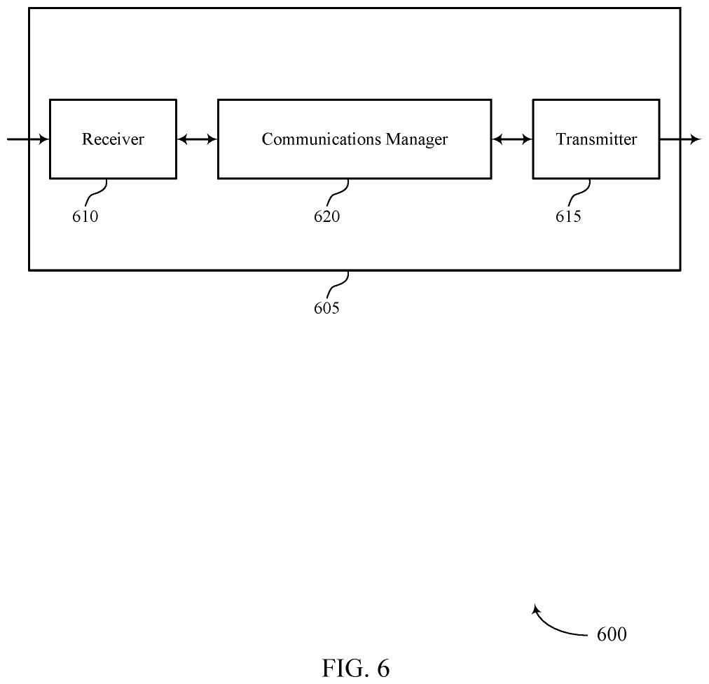

FIG. 6 shows a block diagram 600 of a device 605 that supports signaling of SRS grouping in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to signaling of SRS grouping). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to signaling of SRS grouping). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of signaling of SRS grouping as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. For example, the communications manager 620 may be configured as or otherwise support a means for identifying one or more antenna groups at the UE, each of the one or more antenna groups including two or more antenna ports and associated with group-based SRS transmission. The communications manager 620 may be configured as or otherwise support a means for receiving an indication of an SRS configuration identifying one or more resources for performing group-based SRS transmissions using at least one of the one or more antenna groups. The communications manager 620 may be configured as or otherwise support a means for transmitting one or more SRSs using the one or more resources and at least one antenna port from the at least one of the one or more antenna groups.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for indicating SRS resource configurations to UE identifying SRS resources for full and/or partial SRS sounding.

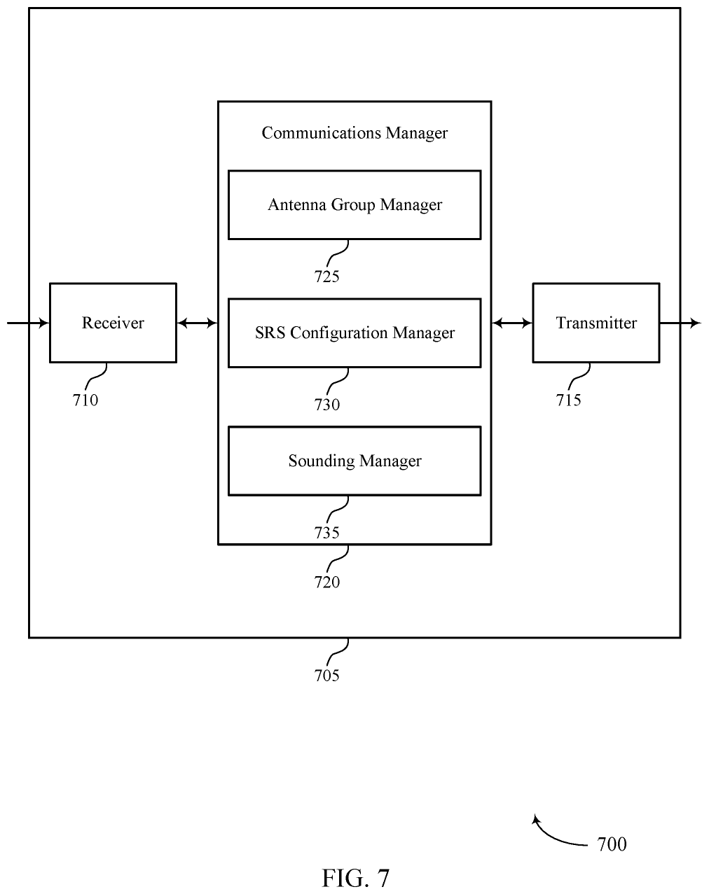

FIG. 7 shows a block diagram 700 of a device 705 that supports signaling of SRS grouping in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to signaling of SRS grouping). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to signaling of SRS grouping). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of signaling of SRS grouping as described herein. For example, the communications manager 720 may include an antenna group manager 725, an SRS configuration manager 730, a sounding manager 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. The antenna group manager 725 may be configured as or otherwise support a means for identifying one or more antenna groups at the UE, each of the one or more antenna groups including two or more antenna ports and associated with group-based SRS transmission. The SRS configuration manager 730 may be configured as or otherwise support a means for receiving an indication of an SRS configuration identifying one or more resources for performing group-based SRS transmissions using at least one of the one or more antenna groups. The sounding manager 735 may be configured as or otherwise support a means for transmitting one or more SRSs using the one or more resources and at least one antenna port from the at least one of the one or more antenna groups.

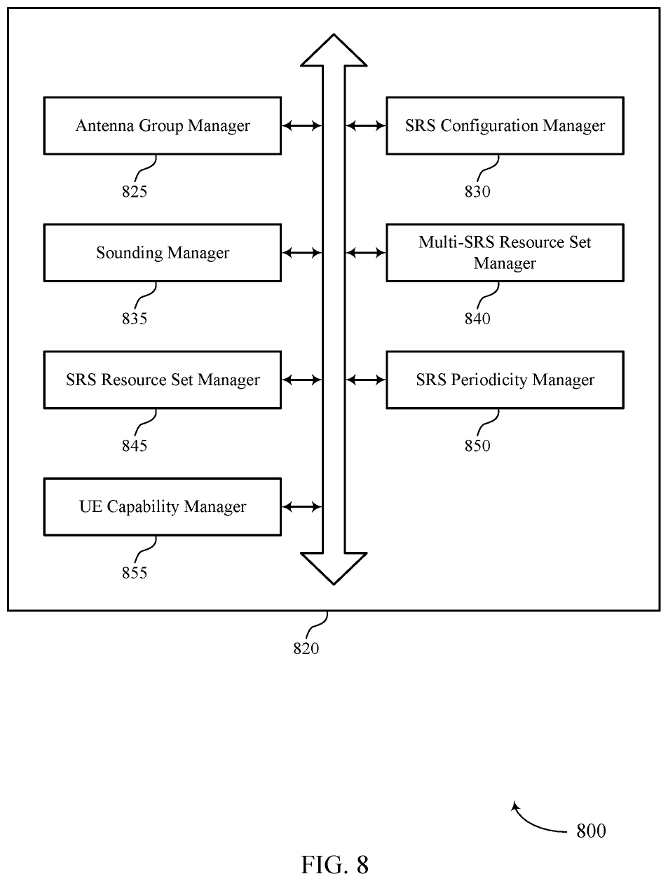

FIG. 8 shows a block diagram 800 of a communications manager 820 that supports signaling of SRS grouping in accordance with aspects of the present disclosure. The communications manager 820 may be an example of aspects of a communications manager 620, a communications manager 720, or both, as described herein. The communications manager 820, or various components thereof, may be an example of means for performing various aspects of signaling of SRS grouping as described herein. For example, the communications manager 820 may include an antenna group manager 825, an SRS configuration manager 830, a sounding manager 835, a multi-SRS resource set manager 840, an SRS resource set manager 845, an SRS periodicity manager 850, a UE capability manager 855, or any combination thereof. Each of these components may communicate, directly or indirectly, with one another (e.g., via one or more buses).

The communications manager 820 may support wireless communication at a UE in accordance with examples as disclosed herein. The antenna group manager 825 may be configured as or otherwise support a means for identifying one or more antenna groups at the UE, each of the one or more antenna groups including two or more antenna ports and associated with group-based SRS transmission. The SRS configuration manager 830 may be configured as or otherwise support a means for receiving an indication of an SRS configuration identifying one or more resources for performing group-based SRS transmissions using at least one of the one or more antenna groups. The sounding manager 835 may be configured as or otherwise support a means for transmitting one or more SRSs using the one or more resources and at least one antenna port from the at least one of the one or more antenna groups.

In some examples, the multi-SRS resource set manager 840 may be configured as or otherwise support a means for identifying, based on the SRS configuration, a set of multiple resource sets. In some examples, the multi-SRS resource set manager 840 may be configured as or otherwise support a means for selecting one of the set of multiple resource sets for transmission of the one or more SRSs, the one of the set of multiple resource sets including the one or more resources.

In some examples, the set of multiple resource sets include a first resource set associated with a full resource set identifier indicative of first resources to be used for a sounding using all of the one or more antenna groups, and a second resource set associated with a partial resource identifier indicative of second resources to be used for a sounding using fewer than all of the one or more antenna groups. In some examples, the first resources and the second resources are different. In some examples, the set of multiple resource sets include a first resource set associated with a full resource set identifier indicative of first resources to be used for a sounding using all of the one or more antenna groups, and a set of multiple second resource sets each associated with a partial resource identifier indicative of corresponding second resources to be used for a sounding using fewer than all of the one or more antenna groups.

In some examples, the SRS resource set manager 845 may be configured as or otherwise support a means for identifying, based on the SRS configuration, a resource set including the one or more resources, the one or more resources associated with a partial resource identifier indicating that the one or more resources are to be used for a sounding using fewer than all of the one or more antenna groups. In some examples, the SRS resource set manager 845 may be configured as or otherwise support a means for identifying, based on the SRS configuration, a number of antennas to be sounded within the one or more antenna groups.

In some examples, to support transmitting the one or more SRSs, the SRS periodicity manager 850 may be configured as or otherwise support a means for transmitting, during a first time period, a first set of full SRS transmissions. In some examples, to support transmitting the one or more SRSs, the SRS periodicity manager 850 may be configured as or otherwise support a means for transmitting, during a second time period, a second set of partial SRS transmissions.

In some examples, the SRS periodicity manager 850 may be configured as or otherwise support a means for receiving a trigger indicating to switch from the first time period where the first set of full SRS transmissions occur to the second time period where the second set of partial SRS transmissions occur. In some examples, the SRS periodicity manager 850 may be configured as or otherwise support a means for identifying, based on the SRS configuration, a periodicity associated with the first time period, the second time period, or both, where switching from the first time period to the second time period is based on the periodicity. In some examples, the trigger is received via at least one of a DCI message, a MAC CE, or both.

In some examples, the SRS periodicity manager 850 may be configured as or otherwise support a means for identifying, based on the trigger, a partial resource identifier indicating that one or more resources are to be used for a sounding using fewer than all of the one or more antenna groups. In some examples, the trigger indicates either a full resource set identifier indicative of first resources to be used for a sounding using all of the one or more antenna groups during the first time period or a partial resource identifier indicative of corresponding second resources to be used for a sounding using fewer than all of the one or more antenna groups during the second time period. In some examples, the trigger indicates common resources to be used for a sounding using all of the one or more antenna groups during the first time period and for a sounding using fewer than all of the one or more antenna groups during the second time period.

In some examples, the UE capability manager 855 may be configured as or otherwise support a means for transmitting a UE capability message identifying the one or more antenna groups at the UE, where the indication of the SRS configuration identifying the one or more resources is received based on the UE capability message.

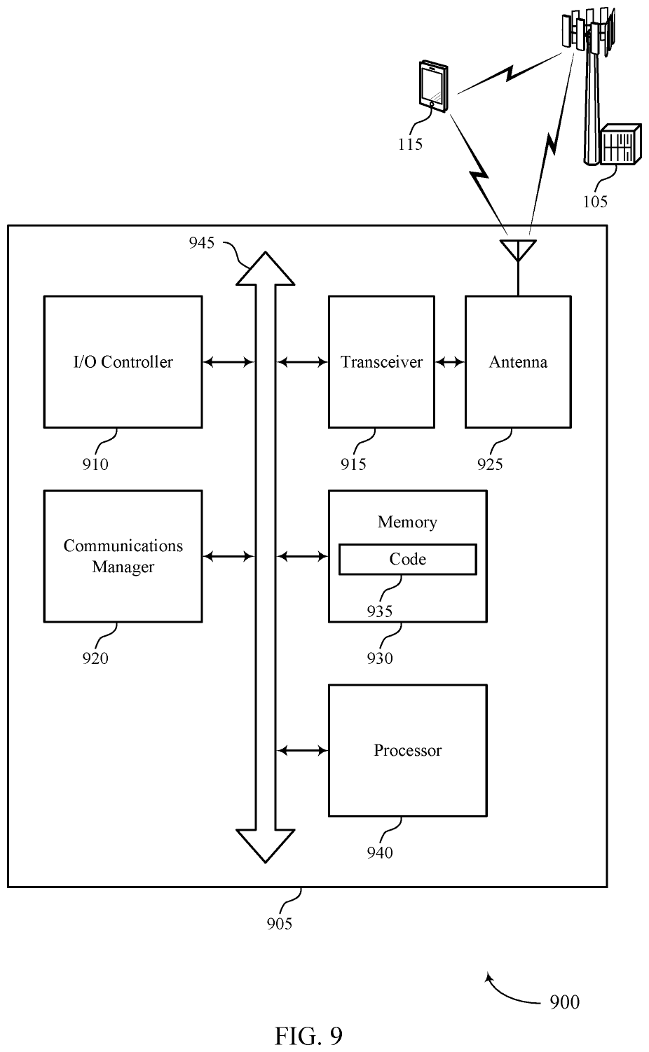

FIG. 9 shows a diagram of a system 900 including a device 905 that supports signaling of SRS grouping in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting signaling of SRS grouping). For example, the device 905 or a component of the device 905 may include a processor 940 and memory 930 coupled to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for identifying one or more antenna groups at the UE, each of the one or more antenna groups including two or more antenna ports and associated with group-based SRS transmission. The communications manager 920 may be configured as or otherwise support a means for receiving an indication of an SRS configuration identifying one or more resources for performing group-based SRS transmissions using at least one of the one or more antenna groups. The communications manager 920 may be configured as or otherwise support a means for transmitting one or more SRSs using the one or more resources and at least one antenna port from the at least one of the one or more antenna groups.

By including or configuring the communications manager 920 in accordance with examples as described herein, the device 905 may support techniques for indicating SRS resource configurations to UE identifying SRS resources for full and/or partial SRS sounding.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of signaling of SRS grouping as described herein, or the processor 940 and the memory 930 may be otherwise configured to perform or support such operations.

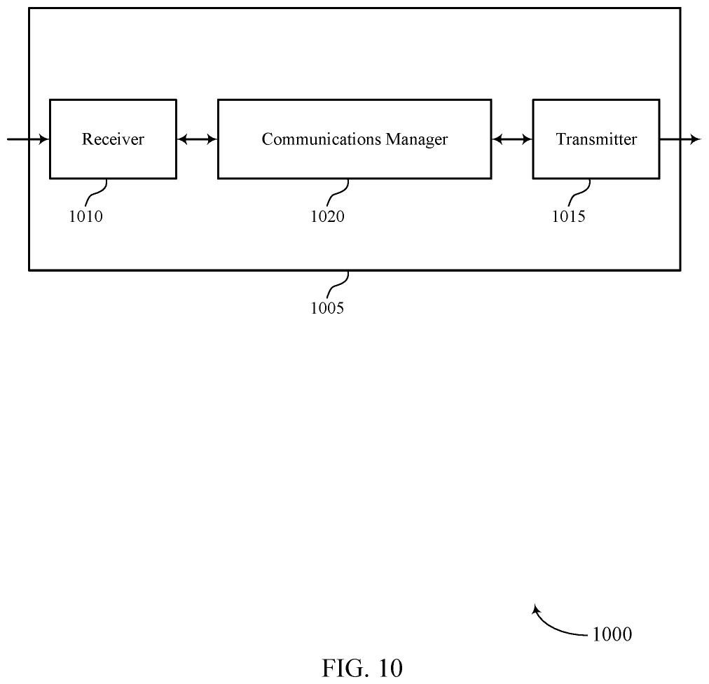

FIG. 10 shows a block diagram 1000 of a device 1005 that supports signaling of SRS grouping in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to signaling of SRS grouping). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to signaling of SRS grouping). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of signaling of SRS grouping as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a base station in accordance with examples as disclosed herein. For example, the communications manager 1020 may be configured as or otherwise support a means for identifying one or more antenna groups at a UE, each of the one or more antenna groups including two or more antenna ports and associated with group-based SRS transmission. The communications manager 1020 may be configured as or otherwise support a means for transmitting an indication of an SRS configuration identifying one or more resources for performing group-based SRS transmissions from the UE using at least one of the one or more antenna groups. The communications manager 1020 may be configured as or otherwise support a means for receiving one or more SRSs using the one or more resources and at least one antenna port from the at least one of the one or more antenna groups.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for indicating SRS resource configurations to UE identifying SRS resources for full and/or partial SRS sounding.

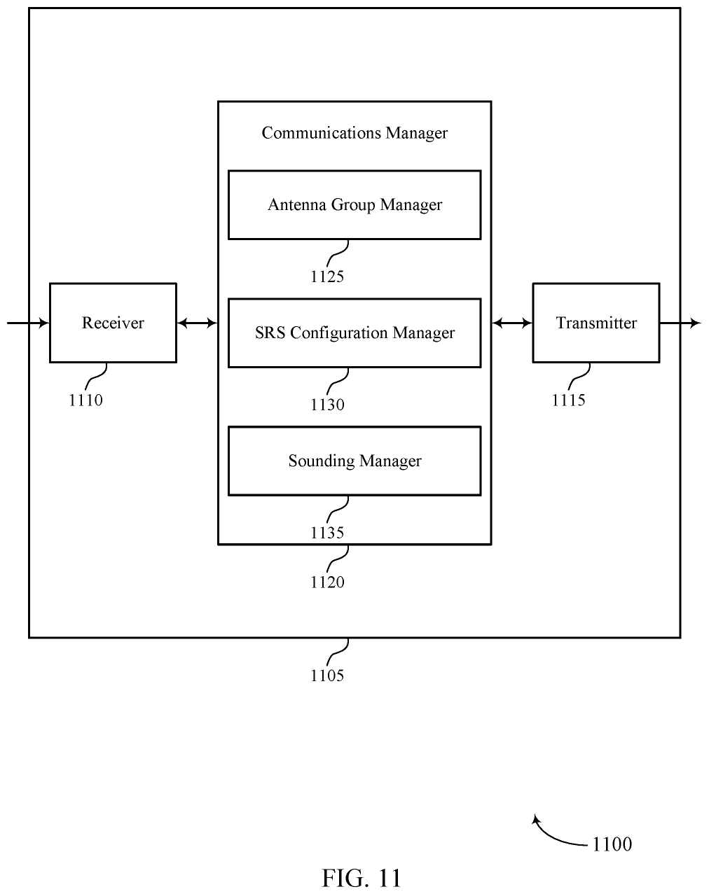

FIG. 11 shows a block diagram 1100 of a device 1105 that supports signaling of SRS grouping in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to signaling of SRS grouping). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to signaling of SRS grouping). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of signaling of SRS grouping as described herein. For example, the communications manager 1120 may include an antenna group manager 1125, an SRS configuration manager 1130, a sounding manager 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a base station in accordance with examples as disclosed herein. The antenna group manager 1125 may be configured as or otherwise support a means for identifying one or more antenna groups at a UE, each of the one or more antenna groups including two or more antenna ports and associated with group-based SRS transmission. The SRS configuration manager 1130 may be configured as or otherwise support a means for transmitting an indication of an SRS configuration identifying one or more resources for performing group-based SRS transmissions from the UE using at least one of the one or more antenna groups. The sounding manager 1135 may be configured as or otherwise support a means for receiving one or more SRSs using the one or more resources and at least one antenna port from the at least one of the one or more antenna groups.

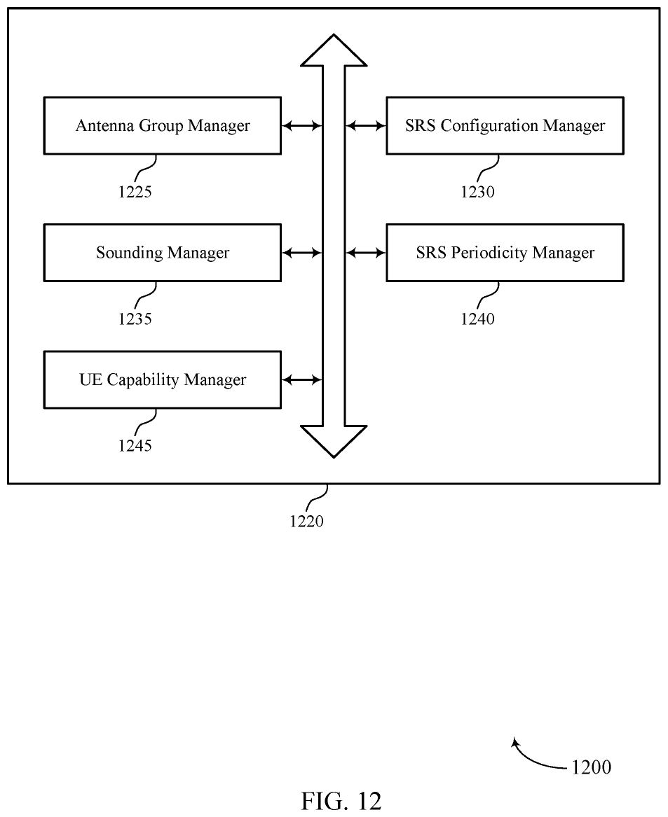

FIG. 12 shows a block diagram 1200 of a communications manager 1220 that supports signaling of SRS grouping in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of signaling of SRS grouping as described herein. For example, the communications manager 1220 may include an antenna group manager 1225, an SRS configuration manager 1230, a sounding manager 1235, an SRS periodicity manager 1240, a UE capability manager 1245, or any combination thereof. Each of these components may communicate, directly or indirectly, with one another (e.g., via one or more buses).

The communications manager 1220 may support wireless communication at a base station in accordance with examples as disclosed herein. The antenna group manager 1225 may be configured as or otherwise support a means for identifying one or more antenna groups at a UE, each of the one or more antenna groups including two or more antenna ports and associated with group-based SRS transmission. The SRS configuration manager 1230 may be configured as or otherwise support a means for transmitting an indication of an SRS configuration identifying one or more resources for performing group-based SRS transmissions from the UE using at least one of the one or more antenna groups. The sounding manager 1235 may be configured as or otherwise support a means for receiving one or more SRSs using the one or more resources and at least one antenna port from the at least one of the one or more antenna groups.

In some examples, the SRS configuration identifies a set of multiple resource sets. In some examples, one of the set of multiple resource sets is selected by the UE for transmission of the one or more SRSs, the one of the set of multiple resource sets including the one or more resources. In some examples, the set of multiple resource sets include a first resource set associated with a full resource set identifier indicative of first resources to be used for a sounding using all of the one or more antenna groups, and a second resource set associated with a partial resource identifier indicative of second resources to be used for a sounding using fewer than all of the one or more antenna groups. In some examples, the first resources and the second resources are different.

In some examples, the set of multiple resource sets include a first resource set associated with a full resource set identifier indicative of first resources to be used for a sounding using all of the one or more antenna groups, and a set of multiple second resource sets each associated with a partial resource identifier indicative of corresponding second resources to be used for a sounding using fewer than all of the one or more antenna groups. In some examples, the SRS configuration identifies a resource set including the one or more resources, the one or more resources associated with a partial resource identifier indicating that the one or more resources are to be used for a sounding using fewer than all of the one or more antenna groups. In some examples, the SRS configuration identifies a number of antennas to be sounded within the one or more antenna groups.

In some examples, to support receiving the one or more SRSs, the SRS periodicity manager 1240 may be configured as or otherwise support a means for receiving, during a first time period, a first set of full SRS transmissions. In some examples, to support receiving the one or more SRSs, the SRS periodicity manager 1240 may be configured as or otherwise support a means for receiving, during a second time period, a second set of partial SRS transmissions.

In some examples, the SRS periodicity manager 1240 may be configured as or otherwise support a means for transmitting a trigger indicating to switch from the first time period where the first set of full SRS transmissions occur to the second time period where the second set of partial SRS transmissions occur. In some examples, the SRS configuration identifies a periodicity associated with the first time period, the second time period, or both. In some examples, the UE switching from the first time period to the second time period is based on the periodicity. In some examples, the trigger is transmitted via at least one of a DCI message, a MAC CE, or both.

In some examples, the SRS periodicity manager 1240 may be configured as or otherwise support a means for identifying, in the trigger, a partial resource identifier indicating that one or more resources are to be used for a sounding using fewer than all of the one or more antenna groups. In some examples, the trigger indicates either a full resource set identifier indicative of first resources to be used for a sounding using all of the one or more antenna groups during the first time period or a partial resource identifier indicative of corresponding second resources to be used for a sounding using fewer than all of the one or more antenna groups during the second time period. In some examples, the trigger indicates common resources to be used for a sounding using all of the one or more antenna groups during the first time period and for a sounding using fewer than all of the one or more antenna groups during the second time period.

In some examples, the UE capability manager 1245 may be configured as or otherwise support a means for receiving a UE capability message identifying the one or more antenna groups at the UE, where the indication of the SRS configuration identifying the one or more resources is transmitted based on the UE capability message.

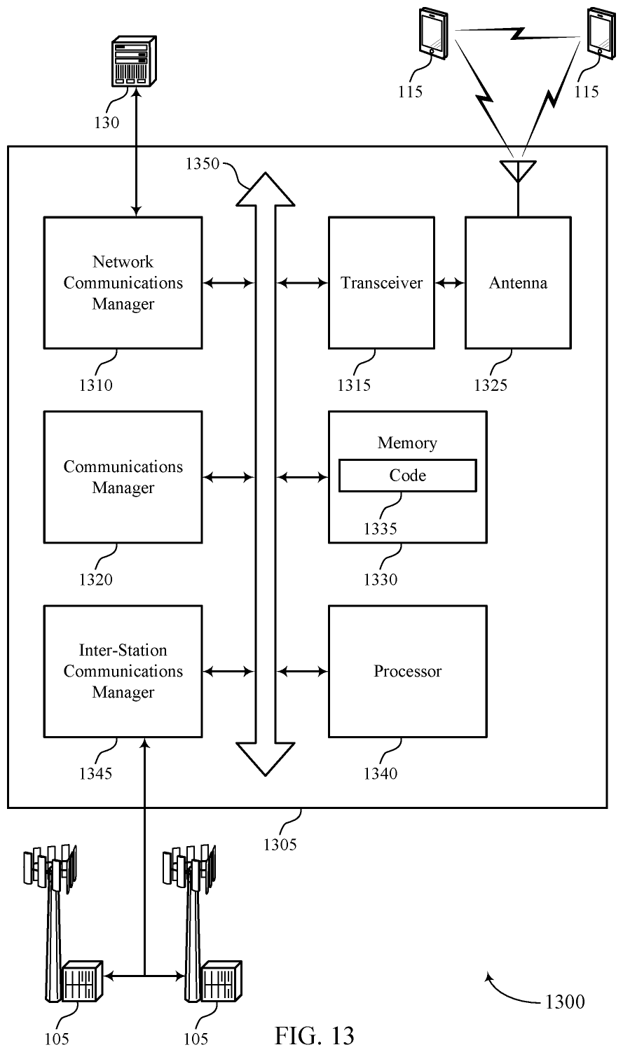

FIG. 13 shows a diagram of a system 1300 including a device 1305 that supports signaling of SRS grouping in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting signaling of SRS grouping). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communication at a base station in accordance with examples as disclosed herein. For example, the communications manager 1320 may be configured as or otherwise support a means for identifying one or more antenna groups at a UE, each of the one or more antenna groups including two or more antenna ports and associated with group-based SRS transmission. The communications manager 1320 may be configured as or otherwise support a means for transmitting an indication of an SRS configuration identifying one or more resources for performing group-based SRS transmissions from the UE using at least one of the one or more antenna groups. The communications manager 1320 may be configured as or otherwise support a means for receiving one or more SRSs using the one or more resources and at least one antenna port from the at least one of the one or more antenna groups.

By including or configuring the communications manager 1320 in accordance with examples as described herein, the device 1305 may support techniques for indicating SRS resource configurations to UE identifying SRS resources for full and/or partial SRS sounding.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of signaling of SRS grouping as described herein, or the processor 1340 and the memory 1330 may be otherwise configured to perform or support such operations.

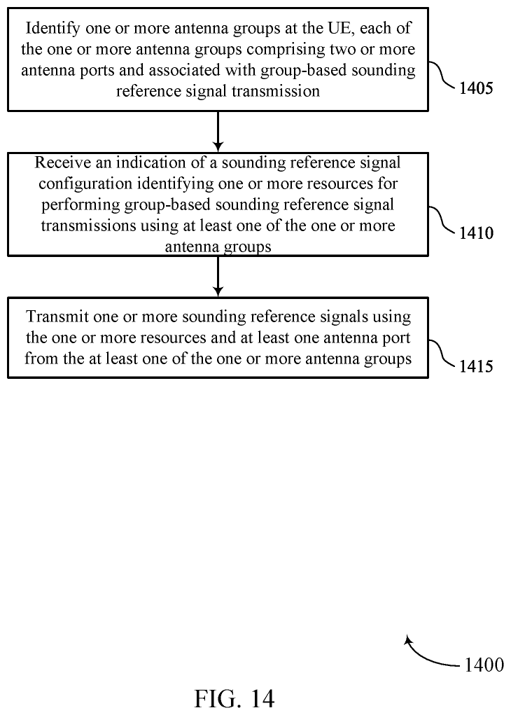

FIG. 14 shows a flowchart illustrating a method 1400 that supports signaling of SRS grouping in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include identifying one or more antenna groups at the UE, each of the one or more antenna groups including two or more antenna ports and associated with group-based SRS transmission. The operations of 1405 may be performed in accordance with examples as disclosed herein. In some examples, aspects of the operations of 1405 may be performed by an antenna group manager 825 as described with reference to FIG. 8.

At 1410, the method may include receiving an indication of an SRS configuration identifying one or more resources for performing group-based SRS transmissions using at least one of the one or more antenna groups. The operations of 1410 may be performed in accordance with examples as disclosed herein. In some examples, aspects of the operations of 1410 may be performed by an SRS configuration manager 830 as described with reference to FIG. 8.

At 1415, the method may include transmitting one or more SRSs using the one or more resources and at least one antenna port from the at least one of the one or more antenna groups. The operations of 1415 may be performed in accordance with examples as disclosed herein. In some examples, aspects of the operations of 1415 may be performed by a sounding manager 835 as described with reference to FIG. 8.

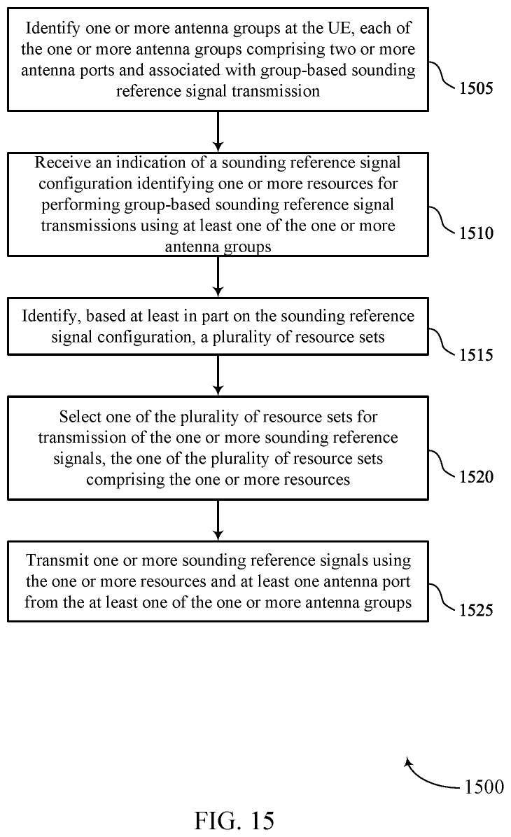

FIG. 15 shows a flowchart illustrating a method 1500 that supports signaling of SRS grouping in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include identifying one or more antenna groups at the UE, each of the one or more antenna groups including two or more antenna ports and associated with group-based SRS transmission. The operations of 1505 may be performed in accordance with examples as disclosed herein. In some examples, aspects of the operations of 1505 may be performed by an antenna group manager 825 as described with reference to FIG. 8.

At 1510, the method may include receiving an indication of an SRS configuration identifying one or more resources for performing group-based SRS transmissions using at least one of the one or more antenna groups. The operations of 1510 may be performed in accordance with examples as disclosed herein. In some examples, aspects of the operations of 1510 may be performed by an SRS configuration manager 830 as described with reference to FIG. 8.

At 1515, the method may include identifying, based on the SRS configuration, a set of multiple resource sets. The operations of 1515 may be performed in accordance with examples as disclosed herein. In some examples, aspects of the operations of 1515 may be performed by a multi-SRS resource set manager 840 as described with reference to FIG. 8.

At 1520, the method may include selecting one of the set of multiple resource sets for transmission of the one or more SRSs, the one of the set of multiple resource sets including the one or more resources. The operations of 1520 may be performed in accordance with examples as disclosed herein. In some examples, aspects of the operations of 1520 may be performed by a multi-SRS resource set manager 840 as described with reference to FIG. 8.

At 1525, the method may include transmitting one or more SRSs using the one or more resources and at least one antenna port from the at least one of the one or more antenna groups. The operations of 1525 may be performed in accordance with examples as disclosed herein. In some examples, aspects of the operations of 1525 may be performed by a sounding manager 835 as described with reference to FIG. 8.

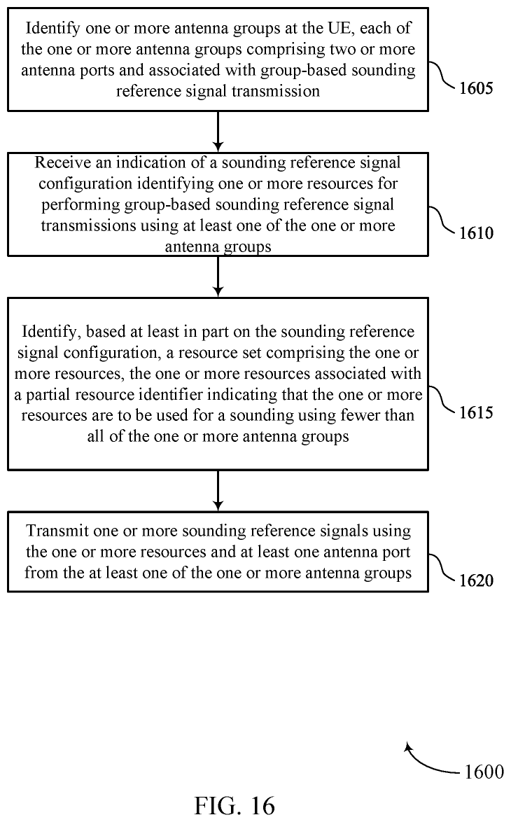

FIG. 16 shows a flowchart illustrating a method 1600 that supports signaling of SRS grouping in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include identifying one or more antenna groups at the UE, each of the one or more antenna groups including two or more antenna ports and associated with group-based SRS transmission. The operations of 1605 may be performed in accordance with examples as disclosed herein. In some examples, aspects of the operations of 1605 may be performed by an antenna group manager 825 as described with reference to FIG. 8.

At 1610, the method may include receiving an indication of an SRS configuration identifying one or more resources for performing group-based SRS transmissions using at least one of the one or more antenna groups. The operations of 1610 may be performed in accordance with examples as disclosed herein. In some examples, aspects of the operations of 1610 may be performed by an SRS configuration manager 830 as described with reference to FIG. 8.

At 1615, the method may include identifying, based on the SRS configuration, a resource set including the one or more resources, the one or more resources associated with a partial resource identifier indicating that the one or more resources are to be used for a sounding using fewer than all of the one or more antenna groups. The operations of 1615 may be performed in accordance with examples as disclosed herein. In some examples, aspects of the operations of 1615 may be performed by an SRS resource set manager 845 as described with reference to FIG. 8.

At 1620, the method may include transmitting one or more SRSs using the one or more resources and at least one antenna port from the at least one of the one or more antenna groups. The operations of 1620 may be performed in accordance with examples as disclosed herein. In some examples, aspects of the operations of 1620 may be performed by a sounding manager 835 as described with reference to FIG. 8.

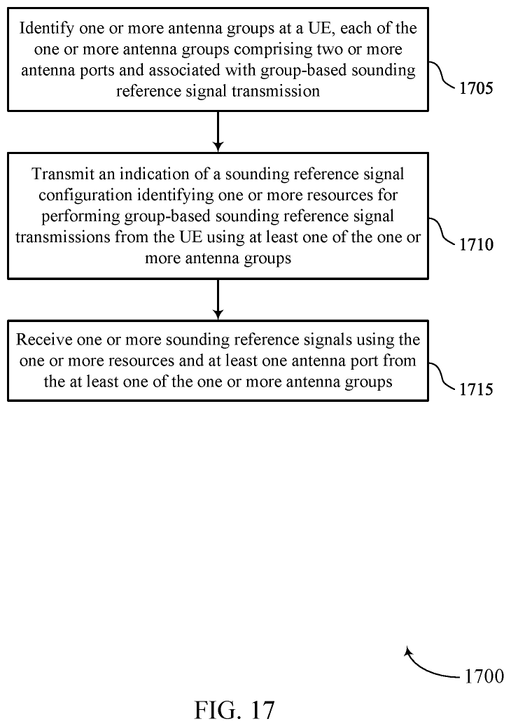

FIG. 17 shows a flowchart illustrating a method 1700 that supports signaling of SRS grouping in accordance with aspects of the present disclosure. The operations of the method 1700 may be implemented by a base station or its components as described herein. For example, the operations of the method 1700 may be performed by a base station 105 as described with reference to FIGS. 1 through 5 and 10 through 13. In some examples, a base station may execute a set of instructions to control the functional elements of the base station to perform the described functions. Additionally, or alternatively, the base station may perform aspects of the described functions using special-purpose hardware.

At 1705, the method may include identifying one or more antenna groups at a UE, each of the one or more antenna groups including two or more antenna ports and associated with group-based SRS transmission. The operations of 1705 may be performed in accordance with examples as disclosed herein. In some examples, aspects of the operations of 1705 may be performed by an antenna group manager 1225 as described with reference to FIG. 12.

At 1710, the method may include transmitting an indication of an SRS configuration identifying one or more resources for performing group-based SRS transmissions from the UE using at least one of the one or more antenna groups. The operations of 1710 may be performed in accordance with examples as disclosed herein. In some examples, aspects of the operations of 1710 may be performed by an SRS configuration manager 1230 as described with reference to FIG. 12.

At 1715, the method may include receiving one or more SRSs using the one or more resources and at least one antenna port from the at least one of the one or more antenna groups. The operations of 1715 may be performed in accordance with examples as disclosed herein. In some examples, aspects of the operations of 1715 may be performed by a sounding manager 1235 as described with reference to FIG. 12.

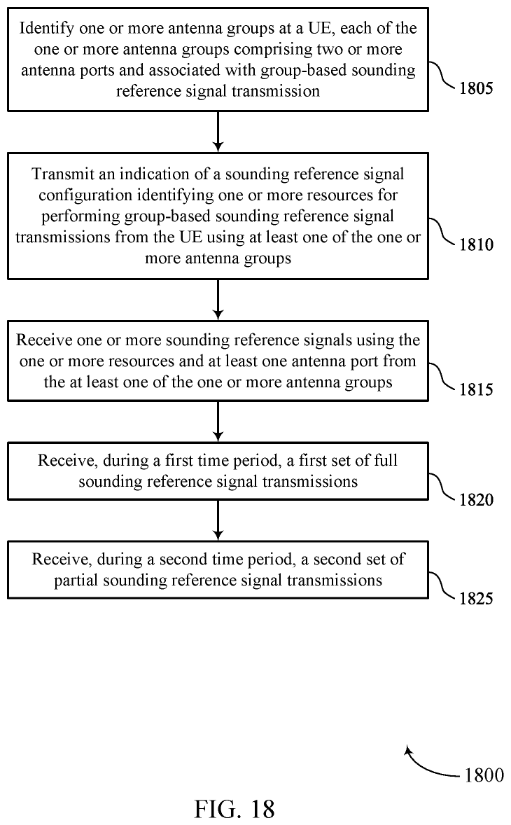

FIG. 18 shows a flowchart illustrating a method 1800 that supports signaling of SRS grouping in accordance with aspects of the present disclosure. The operations of the method 1800 may be implemented by a base station or its components as described herein. For example, the operations of the method 1800 may be performed by a base station 105 as described with reference to FIGS. 1 through 5 and 10 through 13. In some examples, a base station may execute a set of instructions to control the functional elements of the base station to perform the described functions. Additionally, or alternatively, the base station may perform aspects of the described functions using special-purpose hardware.

At 1805, the method may include identifying one or more antenna groups at a UE, each of the one or more antenna groups including two or more antenna ports and associated with group-based SRS transmission. The operations of 1805 may be performed in accordance with examples as disclosed herein. In some examples, aspects of the operations of 1805 may be performed by an antenna group manager 1225 as described with reference to FIG. 12.

At 1810, the method may include transmitting an indication of an SRS configuration identifying one or more resources for performing group-based SRS transmissions from the UE using at least one of the one or more antenna groups. The operations of 1810 may be performed in accordance with examples as disclosed herein. In some examples, aspects of the operations of 1810 may be performed by an SRS configuration manager 1230 as described with reference to FIG. 12.

At 1815, the method may include receiving one or more SRSs using the one or more resources and at least one antenna port from the at least one of the one or more antenna groups. The operations of 1815 may be performed in accordance with examples as disclosed herein. In some examples, aspects of the operations of 1815 may be performed by a sounding manager 1235 as described with reference to FIG. 12.

At 1820, the method may include receiving, during a first time period, a first set of full SRS transmissions. The operations of 1820 may be performed in accordance with examples as disclosed herein. In some examples, aspects of the operations of 1820 may be performed by an SRS periodicity manager 1240 as described with reference to FIG. 12.

At 1825, the method may include receiving, during a second time period, a second set of partial SRS transmissions. The operations of 1825 may be performed in accordance with examples as disclosed herein. In some examples, aspects of the operations of 1825 may be performed by an SRS periodicity manager 1240 as described with reference to FIG. 12.

The following provides an overview of aspects of the present disclosure:

Aspect 1: A method for wireless communication at a UE, comprising: identifying one or more antenna groups at the UE, each of the one or more antenna groups comprising two or more antenna ports and associated with group-based SRS transmission; receiving an indication of a SRS configuration identifying one or more resources for performing group-based SRS transmissions using at least one of the one or more antenna groups; and transmitting one or more SRSs using the one or more resources and at least one antenna port from the at least one of the one or more antenna groups.

Aspect 2: The method of aspect 1, further comprising: identifying, based at least in part on the SRS configuration, a plurality of resource sets; and selecting one of the plurality of resource sets for transmission of the one or more SRSs, the one of the plurality of resource sets comprising the one or more resources.

Aspect 3: The method of aspect 2, wherein the plurality of resource sets comprise a first resource set associated with a full resource set identifier indicative of first resources to be used for a sounding using all of the one or more antenna groups, and a second resource set associated with a partial resource identifier indicative of second resources to be used for a sounding using fewer than all of the one or more antenna groups.

Aspect 4: The method of aspect 3, wherein the first resources and the second resources are different.

Aspect 5: The method of any of aspects 2 through 4, wherein the plurality of resource sets comprise a first resource set associated with a full resource set identifier indicative of first resources to be used for a sounding using all of the one or more antenna groups, and a plurality of second resource sets each associated with a partial resource identifier indicative of corresponding second resources to be used for a sounding using fewer than all of the one or more antenna groups.

Aspect 6: The method of any of aspects 1 through 5, further comprising: identifying, based at least in part on the SRS configuration, a resource set comprising the one or more resources, the one or more resources associated with a partial resource identifier indicating that the one or more resources are to be used for a sounding using fewer than all of the one or more antenna groups.

Aspect 7: The method of aspect 6, further comprising: identifying, based at least in part on the SRS configuration, a number of antennas to be sounded within the one or more antenna groups.

Aspect 8: The method of any of aspects 1 through 7, wherein transmitting the one or more SRSs comprises: transmitting, during a first time period, a first set of full SRS transmissions; and transmitting, during a second time period, a second set of partial SRS transmissions.

Aspect 9: The method of aspect 8, further comprising: receiving a trigger indicating to switch from the first time period where the first set of full SRS transmissions occur to the second time period where the second set of partial SRS transmissions occur.

Aspect 10: The method of aspect 9, further comprising: identifying, based at least in part on the SRS configuration, a periodicity associated with the first time period, the second time period, or both, wherein switching from the first time period to the second time period is based at least in part on the periodicity.

Aspect 11: The method of any of aspects 9 through 10, wherein the trigger is received via at least one of a DCI message, a MAC CE, or both.

Aspect 12: The method of any of aspects 9 through 11, further comprising: identifying, based at least in part on the trigger, a partial resource identifier indicating that one or more resources are to be used for a sounding using fewer than all of the one or more antenna groups.

Aspect 13: The method of any of aspects 9 through 12, wherein the trigger indicates either a full resource set identifier indicative of first resources to be used for a sounding using all of the one or more antenna groups during the first time period or a partial resource identifier indicative of corresponding second resources to be used for a sounding using fewer than all of the one or more antenna groups during the second time period.

Aspect 14: The method of any of aspects 9 through 13, wherein the trigger indicates common resources to be used for a sounding using all of the one or more antenna groups during the first time period and for a sounding using fewer than all of the one or more antenna groups during the second time period.

Aspect 15: The method of any of aspects 1 through 14, further comprising: transmitting a UE capability message identifying the one or more antenna groups at the UE, wherein the indication of the SRS configuration identifying the one or more resources is received based at least in part on the UE capability message.

Aspect 16: A method for wireless communication at a base station, comprising: identifying one or more antenna groups at a UE, each of the one or more antenna groups comprising two or more antenna ports and associated with group-based SRS transmission; transmitting an indication of a SRS configuration identifying one or more resources for performing group-based SRS transmissions from the UE using at least one of the one or more antenna groups; and receiving one or more SRSs using the one or more resources and at least one antenna port from the at least one of the one or more antenna groups.

Aspect 17: The method of aspect 16, wherein the SRS configuration identifies a plurality of resource sets, one of the plurality of resource sets is selected by the UE for transmission of the one or more SRSs, the one of the plurality of resource sets comprising the one or more resources.

Aspect 18: The method of aspect 17, wherein the plurality of resource sets comprise a first resource set associated with a full resource set identifier indicative of first resources to be used for a sounding using all of the one or more antenna groups, and a second resource set associated with a partial resource identifier indicative of second resources to be used for a sounding using fewer than all of the one or more antenna groups.

Aspect 19: The method of aspect 18, wherein the first resources and the second resources are different.

Aspect 20: The method of any of aspects 17 through 19, wherein the plurality of resource sets comprise a first resource set associated with a full resource set identifier indicative of first resources to be used for a sounding using all of the one or more antenna groups, and a plurality of second resource sets each associated with a partial resource identifier indicative of corresponding second resources to be used for a sounding using fewer than all of the one or more antenna groups.

Aspect 21: The method of any of aspects 16 through 20, wherein the SRS configuration identifies a resource set comprising the one or more resources, the one or more resources associated with a partial resource identifier indicating that the one or more resources are to be used for a sounding using fewer than all of the one or more antenna groups.

Aspect 22: The method of aspect 21, wherein the SRS configuration identifies a number of antennas to be sounded within the one or more antenna groups.

Aspect 23: The method of any of aspects 16 through 22, wherein receiving the one or more SRSs comprises: receiving, during a first time period, a first set of full SRS transmissions; and receiving, during a second time period, a second set of partial SRS transmissions.

Aspect 24: The method of aspect 23, further comprising: transmitting a trigger indicating to switch from the first time period where the first set of full SRS transmissions occur to the second time period where the second set of partial SRS transmissions occur.

Aspect 25: The method of aspect 24, wherein the SRS configuration identifies a periodicity associated with the first time period, the second time period, or both, the UE switching from the first time period to the second time period is based at least in part on the periodicity.

Aspect 26: The method of any of aspects 24 through 25, wherein the trigger is transmitted via at least one of a DCI message, a MAC CE, or both.

Aspect 27: The method of any of aspects 24 through 26, further comprising: identifying, in the trigger, a partial resource identifier indicating that one or more resources are to be used for a sounding using fewer than all of the one or more antenna groups.

Aspect 28: The method of any of aspects 24 through 27, wherein the trigger indicates either a full resource set identifier indicative of first resources to be used for a sounding using all of the one or more antenna groups during the first time period or a partial resource identifier indicative of corresponding second resources to be used for a sounding using fewer than all of the one or more antenna groups during the second time period.

Aspect 29: The method of any of aspects 24 through 28, wherein the trigger indicates common resources to be used for a sounding using all of the one or more antenna groups during the first time period and for a sounding using fewer than all of the one or more antenna groups during the second time period.

Aspect 30: The method of any of aspects 16 through 29, further comprising: receiving a UE capability message identifying the one or more antenna groups at the UE, wherein the indication of the SRS configuration identifying the one or more resources is transmitted based at least in part on the UE capability message.

Aspect 31: An apparatus for wireless communication at a UE, comprising a processor; memory coupled with the processor; and instructions stored in the memory and executable by the processor to cause the apparatus to perform a method of any of aspects 1 through 15.

Aspect 32: An apparatus for wireless communication at a UE, comprising at least one means for performing a method of any of aspects 1 through 15.

Aspect 33: A non-transitory computer-readable medium storing code for wireless communication at a UE, the code comprising instructions executable by a processor to perform a method of any of aspects 1 through 15.

Aspect 34: An apparatus for wireless communication at a base station, comprising a processor; memory coupled with the processor; and instructions stored in the memory and executable by the processor to cause the apparatus to perform a method of any of aspects 16 through 30.

Aspect 35: An apparatus for wireless communication at a base station, comprising at least one means for performing a method of any of aspects 16 through 30.

Aspect 36: A non-transitory computer-readable medium storing code for wireless communication at a base station, the code comprising instructions executable by a processor to perform a method of any of aspects 16 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
identifying one or more antenna groups at the UE, each of the one or more antenna groups comprising two or more antenna ports and associated with group-based sounding reference signal transmission;
receiving an indication of a sounding reference signal configuration identifying one or more resources for performing group-based sounding reference signal transmissions using at least one of the one or more antenna groups; and
transmitting one or more sounding reference signals using the one or more resources and at least one antenna port from the at least one of the one or more antenna groups.

2. The method of claim 1, further comprising:
identifying, based at least in part on the sounding reference signal configuration, a plurality of resource sets; and
selecting one of the plurality of resource sets for transmission of the one or more sounding reference signals, the one of the plurality of resource sets comprising the one or more resources.

3. The method of claim 2, wherein the plurality of resource sets comprise a first resource set associated with a full resource set identifier indicative of first resources to be used for a sounding using all of the one or more antenna groups, and a second resource set associated with a partial resource identifier indicative of second resources to be used for a sounding using fewer than all of the one or more antenna groups.

4. The method of claim 3, wherein the first resources and the second resources are different.

5. The method of claim 2, wherein the plurality of resource sets comprise a first resource set associated with a full resource set identifier indicative of first resources to be used for a sounding using all of the one or more antenna groups, and a plurality of second resource sets each associated with a partial resource identifier indicative of corresponding second resources to be used for a sounding using fewer than all of the one or more antenna groups.

6. The method of claim 1, further comprising:
identifying, based at least in part on the sounding reference signal configuration, a resource set comprising the one or more resources, the one or more resources associated with a partial resource identifier indicating that the one or more resources are to be used for a sounding using fewer than all of the one or more antenna groups.

7. The method of claim 6, further comprising:
identifying, based at least in part on the sounding reference signal configuration, a number of antennas to be sounded within the one or more antenna groups.

8. The method of claim 1, wherein transmitting the one or more sounding reference signals comprises:
transmitting, during a first time period, a first set of full sounding reference signal transmissions; and
transmitting, during a second time period, a second set of partial sounding reference signal transmissions.

9. The method of claim 8, further comprising:
receiving a trigger indicating to switch from the first time period where the first set of full sounding reference signal transmissions occur to the second time period where the second set of partial sounding reference signal transmissions occur.

10. The method of claim 9, further comprising:
identifying, based at least in part on the sounding reference signal configuration, a periodicity associated with the first time period, the second time period, or both, wherein switching from the first time period to the second time period is based at least in part on the periodicity.

11. The method of claim 9, wherein the trigger is received via at least one of a downlink control information (DCI) message, a medium access control (MAC) control element (CE), or both.

12. The method of claim 9, further comprising:
identifying, based at least in part on the trigger, a partial resource identifier indicating that one or more resources are to be used for a sounding using fewer than all of the one or more antenna groups.

13. The method of claim 9, wherein the trigger indicates either a full resource set identifier indicative of first resources to be used for a sounding using all of the one or more antenna groups during the first time period or a partial resource identifier indicative of corresponding second resources to be used for a sounding using fewer than all of the one or more antenna groups during the second time period.

14. The method of claim 9, wherein the trigger indicates common resources to be used for a sounding using all of the one or more antenna groups during the first time period and for a sounding using fewer than all of the one or more antenna groups during the second time period.

15. The method of claim 1, further comprising:
transmitting a UE capability message identifying the one or more antenna groups at the UE, wherein the indication of the sounding reference signal configuration identifying the one or more resources is received based at least in part on the UE capability message.

16. A method for wireless communication at a base station, comprising:
identifying one or more antenna groups at a user equipment (UE), each of the one or more antenna groups comprising two or more antenna ports and associated with group-based sounding reference signal transmission;
transmitting an indication of a sounding reference signal configuration identifying one or more resources for performing group-based sounding reference signal transmissions from the UE using at least one of the one or more antenna groups; and
receiving one or more sounding reference signals using the one or more resources and at least one antenna port from the at least one of the one or more antenna groups.

17. The method of claim 16, wherein
the sounding reference signal configuration identifies a plurality of resource sets,
one of the plurality of resource sets is selected by the UE for transmission of the one or more sounding reference signals, the one of the plurality of resource sets comprising the one or more resources.

18. The method of claim 17, wherein the plurality of resource sets comprise a first resource set associated with a full resource set identifier indicative of first resources to be used for a sounding using all of the one or more antenna groups, and a second resource set associated with a partial resource identifier indicative of second resources to be used for a sounding using fewer than all of the one or more antenna groups.

19. The method of claim 18, wherein the first resources and the second resources are different.

20. The method of claim 17, wherein the plurality of resource sets comprise a first resource set associated with a full resource set identifier indicative of first resources to be used for a sounding using all of the one or more antenna groups, and a plurality of second resource sets each associated with a partial resource identifier indicative of corresponding second resources to be used for a sounding using fewer than all of the one or more antenna groups.

21. The method of claim 16, wherein the sounding reference signal configuration identifies a resource set comprising the one or more resources, the one or more resources associated with a partial resource identifier indicating that the one or more resources are to be used for a sounding using fewer than all of the one or more antenna groups.

22. The method of claim 21, wherein the sounding reference signal configuration identifies a number of antennas to be sounded within the one or more antenna groups.

23. The method of claim 16, wherein receiving the one or more sounding reference signals comprises:
receiving, during a first time period, a first set of full sounding reference signal transmissions; and
receiving, during a second time period, a second set of partial sounding reference signal transmissions.

24. The method of claim 23, further comprising:
transmitting a trigger indicating to switch from the first time period where the first set of full sounding reference signal transmissions occur to the second time period where the second set of partial sounding reference signal transmissions occur.

25. The method of claim 24, wherein the sounding reference signal configuration identifies a periodicity associated with the first time period, the second time period, or both, the UE switching from the first time period to the second time period is based at least in part on the periodicity.

26. The method of claim 24, wherein the trigger is transmitted via at least one of a downlink control information (DCI) message, a medium access control (MAC) control element (CE), or both.

27. The method of claim 24, further comprising:
identifying, in the trigger, a partial resource identifier indicating that one or more resources are to be used for a sounding using fewer than all of the one or more antenna groups.

28. The method of claim 24, wherein the trigger indicates either a full resource set identifier indicative of first resources to be used for a sounding using all of the one or more antenna groups during the first time period or a partial resource identifier indicative of corresponding second resources to be used for a sounding using fewer than all of the one or more antenna groups during the second time period.

29. An apparatus for wireless communication at a user equipment (UE), comprising:
a processor;
memory coupled with the processor; and
instructions stored in the memory and executable by the processor to cause the apparatus to:
identify one or more antenna groups at the UE, each of the one or more antenna groups comprising two or more antenna ports and associated with group-based sounding reference signal transmission;
receive an indication of a sounding reference signal configuration identifying one or more resources for performing group-based sounding reference signal transmissions using at least one of the one or more antenna groups; and
transmit one or more sounding reference signals using the one or more resources and at least one antenna port from the at least one of the one or more antenna groups.

30. An apparatus for wireless communication at a base station, comprising:
a processor;
memory coupled with the processor; and
instructions stored in the memory and executable by the processor to cause the apparatus to:
identify one or more antenna groups at a user equipment (UE), each of the one or more antenna groups comprising two or more antenna ports and associated with group-based sounding reference signal transmission;
transmit an indication of a sounding reference signal configuration identifying one or more resources for performing group-based sounding reference signal transmissions from the UE using at least one of the one or more antenna groups; and
receive one or more sounding reference signals using the one or more resources and at least one antenna port from the at least one of the one or more antenna groups.
